(19) United States
(12) Patent Application Publication
(10) Pub. No.: US 2023/0346025 A1
(43) Pub. Date: Nov. 2, 2023

(54) Complex Heating Type Aerosol Generating Device

(71) Applicant: INNO-IT CO., LTD., Busan (KR)

(72) Inventors: Seung Kiu Jeong, Gyeongsangnam-do (KR); Hyuk Won, Busan (KR)

(21) Appl. No.: 17/783,543

(22) PCT Filed: Apr. 29, 2020
(86) PCT No.: PCT/KR2020/005676

§ 371 Date: Jun. 8, 2022

(30) Foreign Application Priority Data
Apr. 29, 2019 (KR) 10-2019-0049485
Apr. 29, 2019 (KR) 10-2019-0049516
Aug. 19, 2019 (KR) 10-2019-0101161
Sep. 27, 2019 (KR) 10-2019-0119336
Apr. 29, 2020 (KR) 10-2020-0051973

(51) Int. Cl. A24F 40/46; A24F 40/20; A24F 40/10; A24F 40/30; A24F 40/51; A24F 40/57; A24F 40/42; A24D 1/20; A24F 40/465; H05B 6/10; H05B 6/06; H05B 3/40

(52) U.S. Cl. CPC A24F 40/46; A24F 40/20; A24F 40/10; A24F 40/30; A24F 40/51; A24F 40/57; A24F 40/42; A24D 1/20; A24F 40/465; H05B 6/108; H05B 6/06; H05B 3/40

(57) ABSTRACT

The present invention relates to an aerosol generating device, and more particularly, to a complex heating type aerosol generating device that can heat a smoking article having a plurality of aerosol-forming substrates. According to an embodiment of the present invention, there is provided a complex heating type aerosol generating device, which is grippable and portable-sized, for a smoking article having a first aerosol-forming substrate and a second aerosol-forming substrate arranged at the upstream of the first aerosol-forming substrate, the complex heating type aerosol generating device comprising: a cavity provided in the device into which the smoking article can be inserted; a first heating means provided in the device to heat the interior or exterior of the first aerosol-forming substrate of the smoking article within a first temperature range; a second heating means provided in the device to heat the interior or exterior of the second aerosol-forming substrate of the smoking article within a second temperature range; first and second sensors provided in the device to sense the temperatures of the first and second heating means, respectively; a rechargeable battery provided in the device to function as a direct current power source; and a control unit provided in the device and electrically connected to the first and second sensors and the battery, to control the first and second heating means according to the sensed values of the first and second sensors, respectively, by receiving direct current power from the battery.

### TECHNICAL FIELD

The present invention relates to an aerosol generating device, and more particularly, to a complex heating type aerosol generating device that can heat a smoking article having a plurality of aerosol-forming substrates.

### BACKGROUND

FIG. 1 is a view showing a prior art induction heating device for heating an aerosol-forming substrate. The induction heating device 1 includes a device housing 10, which may be made of plastic, and a DC power source having a rechargeable battery 11a.

The induction heating device 1 further includes a docking port 12 having a pin 12a for docking the induction heating device 1 with a charging station or a charging apparatus for charging the rechargeable battery 11a. In addition, the induction heating device 1 includes a power supply electronic equipment 13 configured to operate at a desired frequency, e.g., at a frequency of 5 MHz. The power supply electronic equipment 13 is electrically connected to the rechargeable battery 11a through a suitable electric connection 13a.

A tobacco-containing solid aerosol forming substrate 20 including a susceptor 21 is received in a cavity 14 at an extreme end of the device housing 10, and in operation, an inductor L2 (a cylindrical inductor coil wound in a helical type) is inductively coupled to the susceptor 21 of the tobacco-containing solid aerosol forming substrate 20 of a smoking article 2. A filter part 22 of the smoking article 2 is arranged outwardly of the cavity 14 of the induction heating device 1, and in operation, a consumer may inhale an aerosol through the filter part 22.

An induction heating device includes an inductor arranged thermally adjacent to the aerosol-forming substrate, and the aerosol-forming substrate includes a susceptor. An alternating magnetic field of the inductor creates eddy current and hysteresis losses, which cause the susceptor to heat the aerosol-forming substrate to a temperature that allows it to release volatile components able to form an aerosol.

The induction heating device 1 described above does not comprise a construction that can heat a smoking article having a plurality of aerosol-forming substrates. In recent years, the demand for alternatives for addressing the shortcomings of traditional cigarettes is increasing. For instance, there is a growing demand for methods of generating an aerosol by heating an aerosol-generating material in a cigarette, instead of burning tobacco.

Typically, a reconstituted tobacco slurry sheet, which is the main ingredient of the tobacco medium, is not easy to manufacture because of its low tensile strength, and its physical properties are weak because the tobacco medium contains large amounts of humectants. Moreover, the tobacco medium contains a liquid such as glycerin and is sensitive to the humidity in the surroundings due to its hydrophilic nature, which makes it difficult to control the environment of the manufacturing process. Also, the tobacco medium can contain only a limited amount of liquid.

Aside from cigarettes comprising the tobacco medium, there have been proposed ‘hybrid’ cigarettes, which generate more aerosol from liquid contained in a cartomizer and let the user inhale an aerosol derived from the liquid when they puff on the cigarette. However, there are difficulties (expiration date, deterioration, etc.) in managing the liquid contained in the cartomizer, and contamination can occur as condensate is generated in the airflow path through which the aerosol created by the cartomizer moves.

This creates a need to provide a liquid into a smoking article and produce an aerosol from the liquid, rather than discard it after one-time use, and also creates a need for a device that can generate an aerosol using a single smoking article having a variety of different aerosol-forming substrates capable of generating an aerosol.

### SUMMARY

An object of the present invention is to provide a complex heating type aerosol generating device that can heat a smoking article having a plurality of aerosol-forming substrates by a plurality of separately controllable heating means.

According to an aspect of the present invention, there is provided a complex heating type aerosol generating device, which is grippable and portable-sized, for a smoking article having a first aerosol-forming substrate and a second aerosol-forming substrate arranged at the upstream of the first aerosol-forming substrate, the complex heating type aerosol generating device comprising: a cavity provided in the device into which the smoking article can be inserted; a first heating means provided in the device to heat the interior or exterior of the first aerosol-forming substrate of the smoking article within a first temperature range; a second heating means provided in the device to heat the interior or exterior of the second aerosol-forming substrate of the smoking article within a second temperature range; first and second sensors provided in the device to sense the temperatures of the first and second heating means, respectively; a rechargeable battery provided in the device to function as a direct current power source; and a control unit provided in the device and electrically connected to the first and second sensors and the battery, to control the first and second heating means according to the sensed values of the first and second sensors, respectively, by receiving direct current power from the battery.

In some embodiments, the first aerosol-forming substrate provided in the smoking article may be a liquid cartridge, and the second aerosol-forming substrate provided in the smoking article may be a tobacco filler.

In some embodiments, the first aerosol-forming substrate provided in the smoking article may be a tobacco filler, and the second aerosol-forming substrate provided in the smoking article may be a liquid cartridge.

In some embodiments, the first aerosol-forming substrate and second aerosol-forming substrate provided in the smoking article may be tobacco fillers.

In some embodiments, the tobacco filler may contain glycerin VG.

In some embodiments, the first aerosol-forming substrate and second aerosol-forming substrate provided in the smoking article may be liquid cartridges.

In some embodiments, the liquid cartridge may comprise a liquid or gel composition containing glycerin VG.

In some embodiments, the smoking article may further comprise a filter and a tube, the filter, tube, tobacco filler and liquid cartridge being wrapped in single wrapping paper.

In some embodiments, the smoking article may further comprise a filter and a tube, the filter, tube and tobacco filler being wrapped in single wrapping paper.

In some embodiments, the smoking article may further comprise a filter and a tube, the filter, tube and liquid cartridge being wrapped in single wrapping paper.

In some embodiments, the complex heating type aerosol generating device may further comprise a pressure sensor provided in the device and electrically connected to the control unit, wherein the control unit controls the first heating means and/or the second heating means according to the cumulative integral value by calculating the integral value of puff volume according to the sensed value from the pressure sensor.

In some embodiments, the first heating means may be a resistance heater and the second heating means may be an induction heater.

In some embodiments, the first heating means may be an induction heater and the second heating means may be a resistance heater.

In some embodiments, the first heating means may be an induction heater and the second heating means may be an induction heater.

In some embodiments, the first heating means may be a resistance heater and the second heating means may be a resistance heater.

In some embodiments, the resistance heater may be a pipe heater with resistance heating patterns.

In some embodiments, the resistance heater may be an invasive heater.

In some embodiments, the first heating means and second heating means may be integrally formed as an invasive heater that is inserted through the lower center of the smoking article inserted into the cavity and that comes into direct contact with the first aerosol-forming substrate and second aerosol-forming substrate in the smoking article.

In some embodiments, the induction heater may be comprised of an excitation coil and a susceptor reacting with the excitation coil such that induction heating occurs due to eddy current losses to heat the smoking article.

In some embodiments, the complex heating type aerosol generating device may comprise a plurality of capacitor switches provided in the device and connected between the control unit and the excitation coil, wherein the control unit controls a frequency of an alternating current supplied to the excitation coil, by controlling on and off of at least one of the capacitor switches.

In some embodiments, the complex heating type aerosol generating device may comprise a sensor for sensing the inductance of the excitation coil.

In some embodiments, the complex heating type aerosol generating device may comprise a sensor for sensing an impedance of the excitation coil.

In some embodiments, the complex heating type aerosol generating device may comprise an insulating part provided between the susceptor and the excitation coil to prevent heat of the susceptor from being transferred to the excitation coil.

In some embodiments, in the insulating part, an insulating film using an insulating filler having an insulating and shielding function may be attached to an outer wall of an insulating pipe.

In some embodiments, the insulating filler may consist of ceramic powder.

In some embodiments, the susceptor may be provided as a hollow pipe inserted into the center of the first aerosol-forming substrate and/or the second aerosol-forming substrate.

In some embodiments, the susceptor may be made of at least one material selected from stainless steel, nickel and cobalt.

In some embodiments, the induction heater may be comprised of an excitation coil and a susceptor reacting with the excitation coil such that induction heating occurs due to eddy current losses to heat the smoking article, wherein the susceptor is inserted through the lower center of the smoking article inserted into the cavity and comes into direct contact with the second aerosol-forming substrate in the smoking article.

In some embodiments, the resistance heater of the second heating means may be an invasive heater.

The complex heating type aerosol generating device according to the present invention has an advantage of allowing a user to inhale a smoking article having a variety of different aerosol-forming substrates, by using a plurality of heating means capable of controlling the temperatures of the plurality of aerosol-forming substrates, respectively.

The complex heating type aerosol generating device according to the present invention can variably control a heating time, without being restricted by inhalation patterns of a user, by using a pressure sensor to sense a pressure change caused by puffing of the user and controlling on and off of the heating according to the cumulative integral value of puff volume.

The complex heating type aerosol generating device according to the present invention can improve heating efficiency by preventing overheating of an excitation coil with an insulating part provided between the excitation coil and a susceptor.

The complex heating type aerosol generating device according to the present invention can improve heating efficiency by changing a resonance frequency depending on the material of the susceptor.

### BRIEF DESCRIPTION OF THE DRAWINGS

FIG. 1 is a view showing a prior art induction heating device for heating an aerosol-forming substrate.

FIG. 2 conceptually shows a partial exploded perspective view and cross-sectional view of a smoking article according to a preferred embodiment of the present invention, that can be used in the complex heating type aerosol generating device of the present invention.

FIG. 3 conceptually shows components of the smoking article of FIG. 2 and a construction of wrapping paper wrapped around them.

FIG. 4 is a conceptual diagram showing a process of manufacturing an absorbent rod in order to obtain the absorbent of FIG. 3.

FIG. 5 conceptually shows a process of cutting an absorbent rod in order to manufacture a liquid cartridge according to the present invention from the absorbent rod of FIG. 4, that can be provided in the smoking article that can be used in the complex heating type aerosol generating device of the present invention.

FIGS. 6 through 20 are conceptual diagrams given below to show various embodiments of a complex heating type aerosol generating device for generating an aerosol from the smoking article that can be used in the present invention:

FIG. 6 schematically shows a cross-section of a complex heating type aerosol generating device combined with a resistance heater as a first heating means and an induction heater as a second heating means according to a first embodiment, to which the smoking article is applied;

FIG. 7 schematically shows a cross-section of a complex heating type aerosol generating device combined with a resistance heater as a first heating means and an induction heater as a second heating means according to a second embodiment, to which the smoking article is applied;

FIG. 8 schematically shows a cross-section of a complex heating type aerosol generating device combined with a resistance heater as a first heating means and an induction heater as a second heating means according to a third embodiment, to which the smoking article is applied;

FIG. 9 schematically shows a cross-section of a complex heating type aerosol generating device combined with an induction heater as a first heating means and a resistance heater as a second heating means according to a fourth embodiment, to which the smoking article is applied;

FIG. 10 schematically shows a cross-section of a complex heating type aerosol generating device combined with an induction heater as a first heating means and a resistance heater as a second heating means according to a fifth embodiment, to which the smoking article is applied;

FIG. 11 schematically shows a cross-section of a complex heating type aerosol generating device combined with an induction heater as a first heating means and a resistance heater as a second heating means according to a sixth embodiment, to which the smoking article is applied;

FIG. 12 schematically shows a cross-section of a complex heating type aerosol generating device combined with an induction heater as a first heating means and a resistance heater as a second heating means according to a seventh embodiment, to which the smoking article is applied;

FIG. 13 schematically shows a cross-section of a complex heating type aerosol generating device combined with an induction heater as a first heating means and an induction heater as a second heating means according to an eighth embodiment, to which the smoking article is applied;

FIG. 14 schematically shows a cross-section of a complex heating type aerosol generating device combined with an induction heater as a first heating means and an induction heater as a second heating means according to a ninth embodiment, to which the smoking article is applied;

FIG. 15 schematically shows a cross-section of a complex heating type aerosol generating device combined with an induction heater as a first heating means and an induction heater as a second heating means according to a tenth embodiment, to which the smoking article is applied;

FIG. 16 schematically shows a cross-section of a complex heating type aerosol generating device combined with an induction heater as a first heating means and an induction heater as a second heating means according to an eleventh embodiment, to which the smoking article is applied;

FIG. 17 schematically shows a cross-section of a complex heating type aerosol generating device combined with an induction heater as a first heating means and an induction heater as a second heating means according to a twelfth embodiment, to which the smoking article is applied;

FIG. 18 schematically shows a cross-section of a complex heating type aerosol generating device combined with a resistance heater as a first heating means and a resistance heater as a second heating means according to a thirteenth embodiment, to which the smoking article is applied;

FIG. 19 schematically shows a cross-section of a complex heating type aerosol generating device combined with a resistance heater as a first heating means and a resistance heater as a second heating means according to a fourteenth embodiment, to which the smoking article is applied; and

FIG. 20 schematically shows a cross-section of a complex heating type aerosol generating device having a single resistance heater as a first heating means and a second heating means according to a fifteenth embodiment, to which the smoking article is applied.

FIG. 21 is a block diagram showing an embodiment of temperature controlling and heating time controlling in the complex heating type aerosol generating device combined with a resistance heater and an induction heater according to the present invention.

FIG. 22 is a block diagram showing an embodiment of temperature controlling and heating time controlling in the complex heating type aerosol generating device combined with two induction heaters according to the present invention.

FIG. 23 is a block diagram showing an embodiment of temperature controlling and heating time controlling in the complex heating type aerosol generating device combined with two resistance heaters according to the present invention.

FIG. 24 is a graph showing an embodiment of time controlling based on a puff volume in the complex heating type aerosol generating device according to the present invention.

FIG. 25 is a graph showing an embodiment of temperature controlling and heating controlling in the complex heating type aerosol generating device according to the present invention.

FIG. 26 is a circuit block diagram showing an embodiment of resonance frequency regulation by capacitor switch controlling of the control unit in the complex heating type aerosol generating device according to the present invention.

FIG. 27 is a circuit block diagram showing another embodiment of resonance frequency regulation by capacitor switch controlling of the control unit in the complex heating type aerosol generating device according to the present invention.

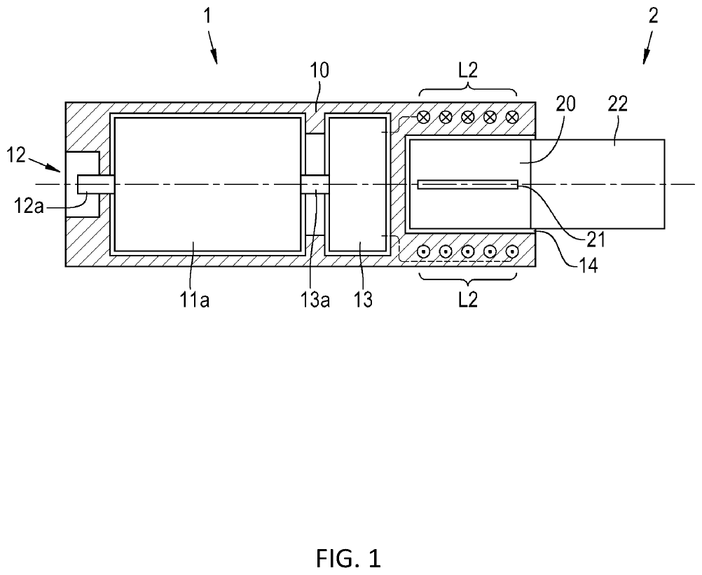

### DETAILED DESCRIPTION

Certain embodiments will now be illustrated in the drawings and described in detail in the description, although various changes and modification can be made thereto. Features and advantages of the present invention and the manner of obtaining them will become more apparent by reference to the following description of the embodiments of the invention, taken in conjunction with the accompanying drawings. The present invention may, however, be embodied in different forms and should not be construed as limited to the embodiments set forth herein.

As used herein, the singular forms “a,” “an” and “the” are intended to include the plural forms as well, unless the context clearly indicates otherwise.

It will be further understood that the terms “comprises”, “comprising”, “includes” and/or “including”, when used herein, specify the presence of stated features or components, but do not preclude the presence or addition of one or more other features or components.

In the following embodiments, the terms “upstream” and “downstream” are used to describe the relative positions of segments of a smoking article in relation to the direction in which a user draws in air through the smoking article. The smoking article includes an upstream end (through which air enters) and an opposite downstream end (through which air exits). In use, the user draws on the downstream end of the smoking article and inhales air that is drawn through the upstream end of the smoking article, passes through the inside of the smoking article, and goes out to the downstream end. The downstream end is downstream of the upstream end. The term “end” may also be described as “extreme end”.

The drawings are not necessarily to scale; some features may be exaggerated or minimized to show details of particular components. Because the size and thickness of each configuration shown in the drawings are arbitrarily shown for better understanding and ease of description, the present invention is not limited thereto.

Example embodiments of the present invention will now be described in detail with reference to the accompanying drawings, so that the present invention can be easily implemented by those skilled in the art. However, the present invention may be implemented in various different ways, without being limited to the described embodiments.

According to an aspect of the present invention, there is provided a complex heating type aerosol generating device, which is grippable and portable-sized, for a smoking article having a first aerosol-forming substrate and a second aerosol-forming substrate arranged at the upstream of the first aerosol-forming substrate, the complex heating type aerosol generating device comprising: a cavity provided in the device into which the smoking article can be inserted; a first heating means provided in the device to heat the interior or exterior of the first aerosol-forming substrate of the smoking article within a first temperature range; a second heating means provided in the device to heat the interior or exterior of the second aerosol-forming substrate of the smoking article within a second temperature range; first and second sensors provided in the device to sense the temperatures of the first and second heating means, respectively; a rechargeable battery provided in the device to function as a direct current power source; and a control unit provided in the device and electrically connected to the first and second sensors and the battery, to control the first and second heating means according to the sensed values of the first and second sensors, respectively, by receiving direct current power from the battery.

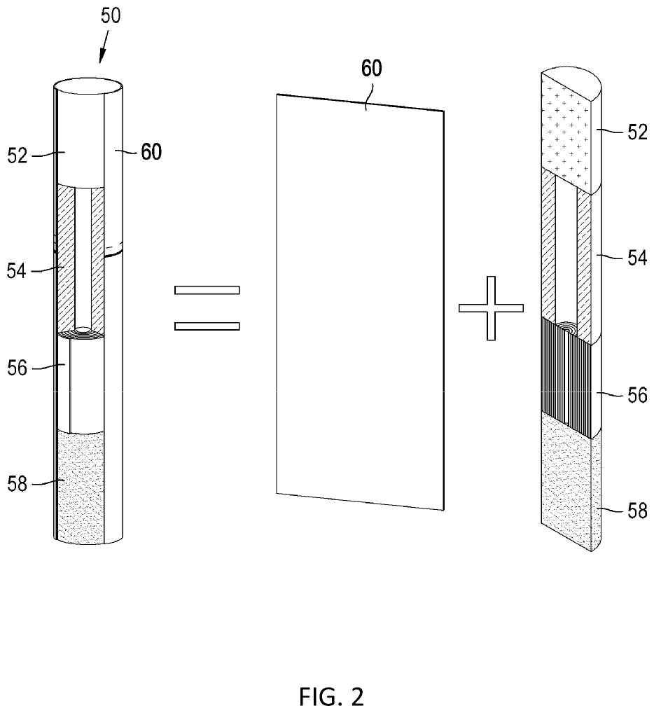

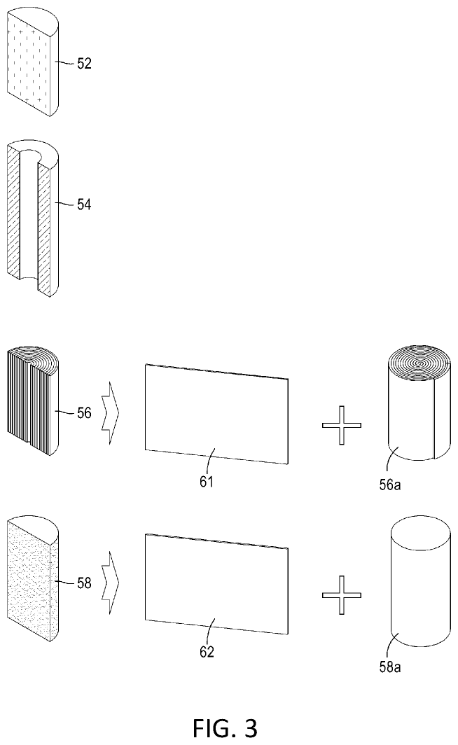

FIG. 2 conceptually shows a partial exploded perspective view and cross-sectional view of a smoking article according to a preferred embodiment of the present invention, that can be used in the complex heating type aerosol generating device of the present invention, and FIG. 3 conceptually shows components of the smoking article of FIG. 2 and a construction of wrapping paper wrapped around them.

The smoking article which can be used in the complex heating type aerosol generating device of the present invention is intended to indicate a smoking article which is heated by electrical resistance or induction heating, not by burning, to generate an aerosol for inhalation by a user. The smoking article contains a proper amount of aerosol-forming substrate and/or shredded tobacco to take an equivalent number of puffs to a single traditional cigarette. The smoking article does not generate any more aerosol after generating a preset amount of aerosol and will be discarded by the user after used once.

The smoking article 50 which can be used in the complex heating type aerosol generating device according to the embodiment of the present invention has a laminate structure composed of a tobacco filler 58 located at the upstream end that contains shredded tobacco as a second aerosol-forming substrate, a liquid cartridge 56 located directly downstream thereof that contains a liquid composition as a first aerosol-forming substrate, a paper tube 54 located directly downstream thereof that provides an aerosol passage, and a filter 52 functioning as a mouthpiece, all of which are wrapped in wrapping paper 60. Although the smoking article 50 of the above-described construction will be described below, the relative positions of the liquid cartridge 56 and the tobacco filler 58 of shredded tobacco may be reversed. In addition, another liquid cartridge 56 may be located as a second aerosol-forming substrate at the upstream end of the liquid cartridge 56 which is a first aerosol-forming substrate, in place of the tobacco filler 58 which is a second aerosol-forming substrate. Further, another tobacco filler 58 may be located as a first aerosol-forming substrate at the downstream end of the tobacco filler 58 which is a second aerosol-forming substrate, in place of the liquid cartridge 56 which is a second aerosol-forming substrate.

The liquid cartridge 56 includes a liquid or gel composition; a liquid or gel absorbent soaked with the liquid or gel composition; and wrapping paper wrapped around the side of the liquid or gel absorbent in a cylindrical shape measuring 7 to 20 mm long and 5 to 8 mm in diameter, wherein the liquid or gel absorbent has a sufficient absorption rate to absorb 70 to 120 mg of liquid composition and keep it in the liquid cartridge. The cylindrical shape measuring 7 to 20 mm long and 5 to 8 mm in diameter meets the standard for regular cigarettes or heating smoking articles being currently used. When the liquid cartridge 56 of the above standard is inserted into the heating smoking article and wrapped in a separate piece of wrapping paper 60, the user will see no difference between the regular cigarettes and the heating smoking articles.

The liquid absorbent of the liquid cartridge 56 of the above standard absorbs 70 to 120 mg of liquid or gel composition, and this numerical range indicates the amount of liquid composition that provides an aerosol derived from the liquid composition when the user inhales an aerosol from the shredded tobacco of a single cigarette stick for the heating smoking article. If the amount of liquid or gel composition absorbed by the liquid absorbent is less than the above lower limit (70 mg), the amount of aerosol derived from the liquid composition when the user inhales an aerosol from the shredded tobacco in the heating smoking article would be insufficient. Thus, the amount of liquid composition absorbed by the liquid cartridge should be equal to or greater than the above lower limit (70 mg). If the amount of liquid or gel composition absorbed by the absorbent exceeds the above upper limit (120 mg), it would be difficult to keep the liquid composition absorbed in the absorbent in the liquid cartridge of the above standard, causing the liquid composition to flow out of the liquid cartridge. Thus, the amount of liquid or gel composition absorbed by the liquid cartridge 56 should be equal to or less than the above upper limit (120 mg). A desirable range is between 80 and 110 mg, and a more desirable range is between 90 and 105 mg.

The liquid absorbent in the liquid cartridge 56 of the above standard has a sufficient absorption rate to keep the liquid composition having the above range in the liquid cartridge. That is, the liquid composition remains absorbed by the liquid absorbent in the liquid cartridge, without flowing out of the liquid cartridge. Here, the absorption means that the absorbent is soaked with the liquid composition which does not flow out. As described below, the filter, tube, liquid cartridge, and tobacco filler are wrapped in the wrapping paper to form the smoking article, wherein the liquid cartridge is brought into direct contact with the tobacco filler or tube or filter without a separate member downstream or upstream, and the liquid composition absorbed by the liquid absorbent of the liquid cartridge is stored in the liquid absorbent, but does not flow out toward the tobacco filler or tube or filter. To this end, preferably, the amount of the liquid composition by the liquid absorbent is 0.13 to 0.32 mg/mm³ per unit volume of the liquid absorbent. This numerical limitation is set for a similar reason to why the numerical limitation is set on the amount of liquid composition absorbed by the absorbent of the present invention. That is, if the amount of liquid composition absorbed by the liquid absorbent is not sufficient, i.e., less than the above lower limit (0.13 mg/mm³), the amount of aerosol derived from the liquid composition when the user inhales an aerosol from the shredded tobacco in the heating smoking article would be insufficient. Thus, the amount of liquid composition absorbed by the liquid cartridge should be equal to or greater than the lower limit (0.13 mg/mm³). If the amount of liquid composition absorbed by the liquid absorbent exceeds the above upper limit (0.32 mg/mm³), it would be difficult to keep the liquid composition absorbed in the liquid absorbent in the liquid cartridge of the above standard, causing the liquid composition to flow out of the liquid cartridge.

The liquid composition contains glycerin VG and optionally contains glycerin PG, water, and flavorings. The liquid composition contains 70 to 100 wt % glycerin VG, 0 to 20 wt % glycerin PG, and 0 to 10 wt % water and further contains flavorings added in an amount that is 10% or less of the total weight of the resulting liquid composition. According to a preferred embodiment, the present invention uses a liquid composition made of 100 wt % glycerin VG. According to another preferred embodiment, the present invention uses a liquid composition made of 80 wt % glycerin VG and 20 wt % glycerin PG. According to a further preferred embodiment, the present invention uses a liquid composition made of 75 wt % glycerin VG, 20 wt % glycerin PG, and 5 wt % water. According to a yet further preferred embodiment, the present invention further contains flavorings added in an amount that is 10% or less of the total weight of the resulting liquid composition. For example, the flavorings may include licorice, sucrose, fructose syrup, isosweet, cocoa, lavender, cinnamon, cardamom, celery, cascarilla, fenugreek, cascarilla, sandalwood, bergamot, geranium, honey essence, rose oil, vanilla, lemon oil, orange oil, mint oil, caraway, cognac, jasmine, chamomile, menthol, ylang-ylang, salvia, spearmint, ginger, coriander, or coffee, etc. In addition, the liquid composition may or may not contain nicotine.

According to a preferred embodiment, the liquid absorbent of the present invention is made by crumpling or rolling a strip made of a melamine-based foam resin with a thickness of 2 to 3 mm into a cylindrical shape. According to another preferred embodiment, the liquid absorbent of the present invention is made by processing a melamine-based foam resin into a cylindrical shape, and more preferably, the liquid absorbent made of the melamine-based foam resin has a weight of 0.01 to 0.013 mg/mm³ per unit volume. According to test results for the smoking article including the liquid cartridge having the liquid absorbent soaked with 100 mg of liquid composition, the liquid composition remained absorbed in the liquid absorbent, without flowing out, during the test, and a sufficient amount of aerosol derived from the liquid composition was observed.

According to a further preferred embodiment, the liquid absorbent of the present invention is made by crumpling or folding or rolling pulp or a fabric containing pulp into a cylindrical shape or by processing it into a cylindrical shape, and more preferably, the liquid absorbent made of pulp or a fabric containing pulp has a weight of 0.25 to 0.4 mg/mm³ per unit volume. According to test results for the smoking article including the liquid cartridge having the liquid absorbent soaked with 100 mg of liquid composition, the liquid composition remained absorbed in the liquid absorbent, without flowing out, during the test, and a sufficient amount of aerosol derived from the liquid composition was observed.

According to a yet further preferred embodiment, the liquid absorbent of the present invention is made by crumpling or rolling a cotton woven fabric or non-woven fabric into a cylindrical shape or by processing it into a cylindrical shape, and more preferably, the liquid absorbent made of a cotton woven fabric or non-woven fabric has a weight of 0.2 to 0.35 mg/mm³ per unit volume. According to test results for the smoking article including the liquid cartridge having the liquid absorbent soaked with 100 mg of liquid composition, the liquid composition remained absorbed in the liquid absorbent, without flowing out, during the test, and a sufficient amount of aerosol derived from the liquid composition was observed.

According to a yet further preferred embodiment, the liquid absorbent of the present invention is made by crumpling or rolling a bamboo fiber woven fabric or non-woven fabric into a cylindrical shape or by processing it into a cylindrical shape, and more preferably, the liquid absorbent made of a bamboo fiber woven fabric or non-woven fabric has a weight of 0.15 to 0.25 mg/mm³ per unit volume. According to test results for the heating smoking article including the liquid cartridge having the liquid absorbent soaked with 100 mg of liquid composition, the liquid composition remained absorbed in the liquid absorbent, without flowing out, during the test, and a sufficient amount of aerosol derived from the liquid composition was observed.

In the smoking article 56 which can be applied to the fine particle generating device according to the present invention, the gel aerosol-forming substrate cartridge contains a gel aerosol-forming substrate which is present in a gel or solid phase at normal temperature and vaporized into an aerosol in a temperature range of 150 to 300° C. and which contains glycerin VG, water and gelatin and optionally contains glycerin PG; a gel receptor for receiving the gel aerosol-forming substrate; and wrapping paper wrapped around the side of the gel receptor in a cylindrical shape measuring 7 to 20 mm long and 5 to 8 mm in diameter. The cylindrical shape measuring 7 to 20 mm long and 5 to 8 mm in diameter meets the standard for regular cigarettes or heating smoking articles being currently used. When the gel aerosol-forming substrate cartridge of the above standard is inserted into the heating smoking article and wrapped in a separate piece of wrapping paper, the user will see no difference between the regular cigarettes and the heating smoking articles.

Here, the gel aerosol-forming substrate includes a liquid composition made of 80 to 100 wt % glycerin VG and 0 to 20 wt % glycerin PG, contains gelatin having a weight of 1 to 6 g in 100 ml of mixture of 60 to 80 wt % liquid composition and 20 to 40 wt % water at a volume ratio, and optically contains flavorings added less than 10 wt % of the total weight of the resulting liquid composition. Here, preferably, the liquid composition may be included in the gel receptor at an amount of 70 to 120 mg. Alternatively, the liquid composition may be included in the gel receptor at an amount of 0.13 to 0.32 mg/mm³ per unit volume of the gel receptor.

The tobacco filler 58 may contain tobacco-based solid substances such as reconstituted tobacco and shredded tobacco. In one embodiment, the tobacco filler 58 may be stuffed with a corrugated reconstituted tobacco sheet. The reconstituted tobacco sheet may have corrugations as it is substantially horizontally rolled around the axis of cylinder, folded, compressed, or shrunken. The porosity may be determined by adjusting the gaps between the corrugations of the reconstituted tobacco sheet.

In another embodiment, the tobacco filler 58 may be stuffed with shredded tobacco. Here, the shredded tobacco may be formed by finely cutting a tobacco sheet (or reconstituted tobacco slurry sheet). Also, the tobacco filler 58 may be formed by combining multiple strands of tobacco together in the same direction (parallel) or randomly. Specifically, the tobacco filler 58 may be formed by combining multiple strands of tobacco together, and may have a plurality of longitudinal channels through which aerosol can pass. The longitudinal channels may be regular or irregular depending on the size and arrangement of the strands of tobacco.

The tobacco filler 58 may additionally comprise at least one among ethylene glycol, dipropylene glycol, diethylene glycol, triethylene glycol, tetraethylene glycol, and oleyl alcohol. The tobacco filler may further comprise glycerin VG, glycerin, and propylene glycol.

Furthermore, the tobacco filler 58 may contain other additives such as flavorings and/or organic acids. For example, the flavoring component may include licorice, sucrose, fructose syrup, isosweet, cocoa, lavender, cinnamon, cardamom, celery, cascarilla, fenugreek, cascarilla, sandalwood, bergamot, geranium, honey essence, rose oil, vanilla, lemon oil, orange oil, mint oil, caraway, cognac, jasmine, chamomile, menthol, ylang-ylang, salvia, spearmint, ginger, coriander, or coffee, etc.

As shown in FIGS. 2 and 3, in the liquid cartridge 56 according to one embodiment of the present invention, the absorbent 56a with the liquid composition absorbed in it is wrapped in the wrapping paper 61 serving as a housing. In addition, the paper tube 54 and the filter 52 are stacked sequentially at the downstream end of the liquid cartridge 56. The filter 52 and the paper tube 54 are wrapped in the wrapping paper 60, together with the liquid cartridge.

The liquid composition in the liquid cartridge 56 remains absorbed in the absorbent in the liquid cartridge 56, without flowing out of the liquid cartridge, and is vaporized by heating to generate an aerosol.

Preferably, the wrapping paper 60, 61 and 62 is made of a material that does not deform when heated to a high temperature or when in contact with liquid, or that does not generate harmful components. Alternatively, the wrapping paper may be made of a metal thin film or metal foil, or, as described above, may be made by adding a metal thin film or thin metal sheet to wrapping paper or by laminating them together. According to a preferred embodiment of the present invention, the wrapping paper 61 serving as a housing for the liquid cartridge 56 is composed of paper and aluminum foil laminated together, and the aluminum foil adjoins the absorbent 56a and therefore prevents the liquid composition absorbed in the absorbent from flowing out to the side of the liquid cartridge 56.

The filter 52 provided downstream of the liquid cartridge 56 may have a hollow portion for generating an airflow, but a filter with no hollow portion may also be used. The filter may be composed of one or more segments and may include at least one of a tube filter, a cooling structure and a recess filter, for example. The tube filter has an inner hollow portion. The tube filter and the recess filter may be made of cellulose acetate, and the tube functioning as the cooling structure may be made of pure polylactic acid (PLA) or a combination of polylactic acid and another degradable polymer.

More specifically, the filter 52 may be made of acetate, paper, PP, etc. and the wrapping paper wrapped around the filter may be classified as regular paper, porous paper, perforated paper, non-wrapped acetate (NWA), etc. In addition, the filter type may be classified as a mono filter composed of one segment or a composite (double, triple, etc.) filter composed of a number of segments. The filter may be made from acetate tow, plasticizer, activated charcoal, X-DNA, and wrapping paper. The acetate tow refers to an aggregate of continuous filaments of cellulose acetate, which plays a major role in determining draw resistance, which is the most important characteristic of the filter. The properties of the acetate tow are determined by denier.

The plasticizer makes cellulose acetate fibers soft and flexible to form bonds at the contact points between the fibers and make a fiber bundle more rigid. Triacetin is used as a plasticizer for cigarette filters.

The activated charcoal, which is one of the absorbents, contains carbon as the main constituent and can be classified by particle size and nature. Source materials used for the activated charcoal include plant materials, such as wood, sawdust, and fruit stones (coconut husk, bamboo, peach seeds, etc.).

X-DNA refers to functional particles that are extracted from sea algae and then condensed and processed. As compared with the activated charcoal mainly used for cigarette filters, X-DNA does not affect the taste of cigarettes and exhibits strong anticarcinogenic effects.

The wrapping paper serves to maintain the shape of a filter plug during the manufacture of the filter. The wrapping paper is required to satisfy physical properties, such as porosity, tensile strength, extension, thickness, glue adhesion, etc., in its manufacture.

For example, the liquid cartridge 56 may be 14.0 mm long, the filter 52 or the tube 54 may be 2.5 mm long, and the tobacco filler 58 containing shredded tobacco may be 9.0 mm long. Alternatively, for example, the filter may be 10 mm, the paper tube 54 may be 16 mm, the liquid cartridge 56 may be 10 mm, and the tobacco filler 58 may be 12 mm.

The relative lengths of the filter 52, paper tube 54, liquid cartridge 56, and tobacco filler 58 and the relative positioning of the liquid cartridge 56 and tobacco filler 58 may be associated with the temperature of an aerosol the user inhales that is generated from the electrically heated smoking article by means of a complex heating type aerosol generating device 100 to be described later. The temperature of an aerosol generated from the liquid cartridge 56 and the temperature of an aerosol generated from the tobacco filler 58 are different, and high-temperature aerosol can be cooled further as the paper tube 54 becomes longer. Thus, the temperatures of aerosols generated from the liquid cartridge 56 and tobacco filler 58 and the relative positioning of the liquid cartridge 56 and tobacco filler 58 may be taken into account, and the relative lengths and positioning of the liquid cartridge 56 and tobacco filler 58 may vary with the amounts of liquid composition and shredded tobacco dependent on the volumes of the liquid cartridge 56 and tobacco filler 58 and the heating method used by the complex heating type aerosol generating device 100 to be described later. It would not be difficult for a person of ordinary skill in the art to satisfy the above conditions when making a smoking article the same size as the smoking articles currently on the market.

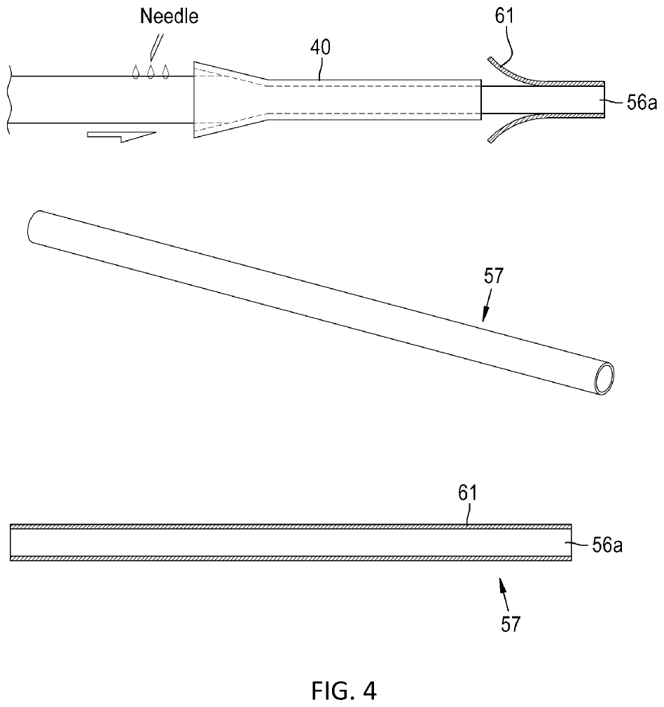

FIG. 4 is a conceptual diagram showing a process of manufacturing an absorbent rod in order to obtain the absorbent of FIG. 3.

According to a preferred embodiment for manufacturing the liquid cartridge 56 shown in FIG. 3, an absorbent formed in a cylinder shape by the pipe structure 40 is passed through spray equipment or a liquid composition injection part such as a needle before it is inserted into the pipe structure 40, and enough of the liquid composition is sprayed or injected into the absorbent 56a, and the absorbent 56a becomes dampened or soaked with the liquid composition as it passes through the pipe structure 40. Afterwards, the absorbent with the liquid composition absorbed in it is wrapped in, for example, wrapping paper (or a laminate of paper and aluminum foil), and cut to a required length (for example, 140 mm, 100 mm, or 80 mm) to form an absorbent rod 57. As described later, the absorbent rod 57 may be cut up into a liquid cartridge 56 of a desired length (for example, 14 mm, 10 mm, or 8 mm), and then packed (wrapped) together with other segments (the tube, filter, and tobacco filler) of the smoking article, thereby making a smoking article 50 for generating an aerosol.

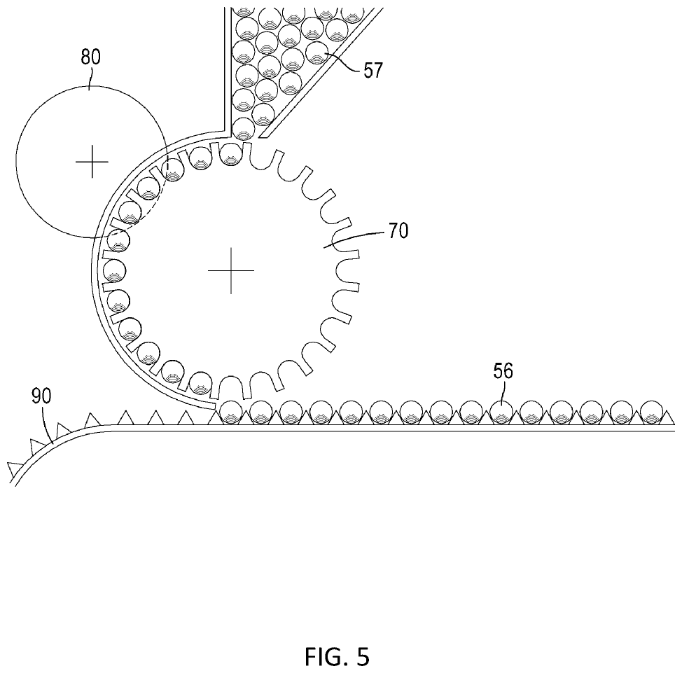

FIG. 5 conceptually shows a process of cutting an absorbent rod in order to manufacture a liquid cartridge according to the present invention from the absorbent rod of FIG. 4, that can be provided in the smoking article that can be used in the complex heating type aerosol generating device of the present invention.

FIG. 5 schematically illustrates a process of cutting the absorbent rod 57 in order to manufacture a liquid cartridge 56. As described previously, the absorbent rod 57, which is 140 mm, 100 mm, or 80 mm long, for example, may be inserted into a groove in an index table 70 and moved to a conveyor belt 90 by the rotation of the index table. At this point, rotary blades 80 are placed on the moving path along the index table 70, and the absorbent rod 57 is cut into ten liquid cartridges 56 of a desired length, for example, 14 mm, 10 mm, or 8 mm by the rotary blades. Ten rotary blades 80 may be placed at equal intervals to cut a 140-mm absorbent rod 57 into ten 14-mm liquid cartridges 56, a 100-mm absorbent rod 57 into ten 10-mm liquid cartridges 56, or an 80-mm absorbent rod 57 into ten 8-mm liquid cartridges 56. As described previously, since the same process and equipment used to add flavoring components to the filter in the conventional manufacturing of cigarettes are employed, there will be no significant difficulties in achieving mass production and quality control.

According to a preferred embodiment of the present invention, the filter 52 functioning as a mouthpiece is located at the downstream end of the liquid cartridge 56, and the tobacco filler 58 containing shredded tobacco is located at the upstream end of the liquid cartridge 56. By packing these segments (filter, liquid cartridge, and tobacco filler) together, a smoking article 50 for generating an aerosol can be made. As described previously, if necessary, the tube 54 which provides an aerosol passage and cools aerosols may be located between the filter 52 and the liquid cartridge 56. All of these segments—filter 52, tube 54, liquid cartridge 56, and tobacco filler 58—are arranged side by side and packed together, thereby obtaining a smoking article 50 for generating an aerosol. In an actual manufacturing line, 10 or more sets of these segments are arranged and wrapped, and then cut into a number of electrically heated smoking articles.

In any case, the liquid composition in the liquid cartridge 56 remains absorbed in the absorbent 56a in the liquid cartridge, and does not flow out of the liquid cartridge 56. Nevertheless, in the process of manufacturing a smoking article or after completing the smoking article, a dried liquid composition may flow out due to high-temperature heat or physical pressure applied to the liquid cartridge, or may be vaporized into an aerosol and exit to the outside. First of all, according to a preferred embodiment of the present invention, the tobacco filler is located upstream of the liquid cartridge, and the filter is located downstream of the liquid cartridge, and therefore it is extremely unlikely that the dried liquid composition may flow out through the filter or tobacco filler even if external physical force is applied to the liquid cartridge. Since the liquid composition starts to generate an aerosol at about 120° C. or higher, any loss of the liquid composition during the manufacturing process can be prevented by performing process control at 100° C. or lower in the process of wrapping or making the liquid cartridge 56. In cases where a high temperature equal to or higher than a temperature where the liquid composition starts to vaporize is required during the manufacturing process, the liquid composition may be controlled in such a way that it is additionally absorbed by estimating the amount of liquid composition lost during the process and adding the estimated amount of loss to a required amount of liquid composition.

Hereinafter, embodiments of a complex heating type aerosol generating device 100 for generating an aerosol by heating the smoking article 50 which can be used in the present invention will be described. The complex heating type aerosol generating device 100 to be described below is a grippable and portable-sized aerosol generating device that has a cavity into which the smoking article 50 is inserted, the smoking article 50 including an aerosol-forming substrate such as a liquid composition or shredded tobacco therein, similar to the smoking article 50 described herein, and being wrapped in wrapping paper in the shape of a traditional cigarette, and that forms an aerosol by heating the aerosol-forming substrate of the smoking article inserted into the cavity by a heating means provided in the aerosol generating device. As stated below, the heating means may be provided in a resistance heating or induction heating manner, which may be heated up to 100 to 400° C. to heat the aerosol-forming substrate within the smoking article 50 inserted into the cavity of the complex heating type aerosol generating device 100, thereby generating an aerosol. According to a preferred embodiment, the target temperature may range between 200 and 350° C., and more preferably, between 250 and 320° C. (for example, the target temperature may be set to 280° C.). In some cases, the target temperature may range between 150 and 250° C. (for example, the target temperature may be set to 180° C.), and may vary depending on whether an aerosol is generated from the liquid composition (glycerin, etc.), the tobacco filler, or the tobacco filler with the liquid composition such as glycerin absorbed in it. In any of theses cases, an aerosol generated in the electrically heated smoking article 50 is inhaled into the mouth of the user through the tube 54 and the filter 52. Thus, if the temperature of the generated aerosol is too high, even if the aerosol is cooled through the inhalation, the user may feel discomfort or get burned. Moreover, too much aerosol may be generated, making it difficult to take multiple puffs. With this taken into consideration, the target temperature of a heating element should be preset. For these reasons, the above upper limit is set on the target temperature of the heating element.

According to a preferred embodiment, the temperature of a generated aerosol measured after it passes through the tube 54 and the filter 52 may be a mouth end temperature. The temperature of the aerosol should be lower than 50° C., preferably, 45° C. or lower. A desirable temperature range for the aerosol at the mouth end is 25 to 45° C., and a more desirable temperature range for the aerosol at the mouth end is 30 to 40° C.

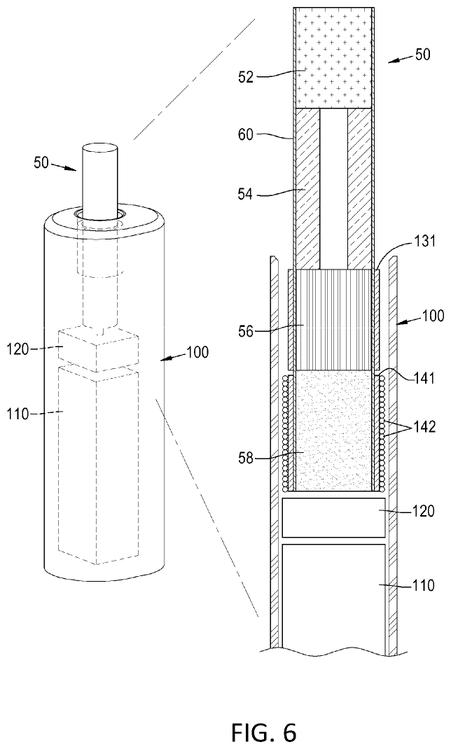

The complex heating type aerosol generating device 100 commonly comprises a rechargeable battery 110 that is provided in the device and functions as a DC power source and a control unit 120 that controls the output from the battery 110. FIG. 6 depicts a conceptual diagram of the complex heating type aerosol generating device 100, together with the smoking article 50, and schematically shows a cross-section of the complex heating type aerosol generating device 100 to explain the heating method for each embodiment. For convenience of explanation, the smoking article 50 will be described basically with respect to a construction in which the filter 52, the tube 54, the liquid cartridge 56 (first aerosol-forming substrate), and the tobacco filler 58 (second aerosol-forming substrate) are arranged in the order named and wrapped in the wrapping paper 60. It should be noted that, as explained earlier, the relative positions of the liquid cartridge 56 and tobacco filler 58 may be reversed. In some embodiments, the filter 52, tube 54, liquid cartridge 56 and liquid cartridge 56 may be arranged in order, or the filter 52, tube 54, tobacco filler 58 and tobacco filler 58 may be arranged in order.

The following descriptions are provided only for illustrative purposes, and the scope of the present invention is not limited thereto. Those skilled in the art to which the present invention pertains will easily understand that an aerosol generating system falling within the scope of the present invention can be constructed by deleting or adding some of the components of the complex heating type aerosol generating device exemplified below or combining it with another device.

FIG. 6 schematically shows a cross-section of a complex heating type aerosol generating device combined with a resistance heater as a first heating means and an induction heater as a second heating means according to a first embodiment, to which the smoking article is applied.

The smoking article 50 is inserted into the complex heating type aerosol generating device 100. The smoking article 50 is constructed by wrapping the filter 52, paper tube 54, liquid cartridge 56, and tobacco filler 58 in the wrapping paper 60, as described above, and is inserted into a cavity formed in the complex heating type aerosol generating device 100.

The complex heating type aerosol generating device 100 comprises a pipe heater 131 as a first heating means for generating an aerosol by heating a liquid composition absorbed by the liquid cartridge 56, and an excitation coil 142 and a susceptor which reacts with the excitation coil 142 so that induction heating occurs due to eddy current losses to heat the tobacco filler 58 as a second heating means for generating an aerosol by heating the shredded tobacco in the tobacco filler 58. Additionally, the complex heating type aerosol generating device 100 comprises a battery 110 for supplying power to the pipe heater 131 and the excitation coil 142 and a control unit 120 configured to control the power supply to the pipe heater 131 and the excitation coil 142 from the battery 110.

The pipe heater 131 according to the first embodiment may be a pipe with a heater line or planar heating element pattern printed or provided on the outside. The pipe heater 131 also has a temperature sensor pattern so as to sense the temperature and control the power supply to the pipe heater 131 according to the sensed value. The pipe heater 131 heats the liquid cartridge 56 of the smoking article 50 from the side of the liquid cartridge 56 so that an aerosol is generated as the liquid composition soaking through or dampening the liquid cartridge 56 is heated.

Here, the susceptor is a metal heat pipe 141 which is provided inside the excitation coil 142 to be surrounded by the excitation coil 142, which is heated to a temperature of 400° C. or lower by induction heating due to eddy current losses, by reaction with the excitation coil 142. The susceptor may be heated to a temperature of 1,000° C. or higher depending on the magnitude of the alternating current applied to the excitation coil 142, whereas, in the present invention, the susceptor functioning as a heating element is heated to a temperature of 400° C. or lower, as stated above. The heat pipe 141 heats the tobacco filler 58 from the side of the tobacco filler 58 to generate an aerosol from the shredded tobacco provided in the tobacco filler 58.

The first heating means and the second heating means may heat the aerosol-forming substrate within a temperature range of 150 to 350° C. to generate an aerosol. The generated aerosol is inhaled through the mouth of the user via the paper tube 54 and the filter 52. In an example, the excitation coil 142 and the susceptor may heat the shredded tobacco in the tobacco filler 58 within a second temperature range of 150 to 250° C. to generate an aerosol derived from the shredded tobacco, and the pipe heater 131 may heat the absorbent in the liquid cartridge 56 within a first temperature range of 250 to 350° C. to generate an aerosol derived from the liquid composition in the absorbent. The above temperature conditions may be reversed. In addition, the second temperature range may overlap with the first temperature range at least in sections. Within the above temperature range, the wrapping paper is not combusted but may be partially scorched.

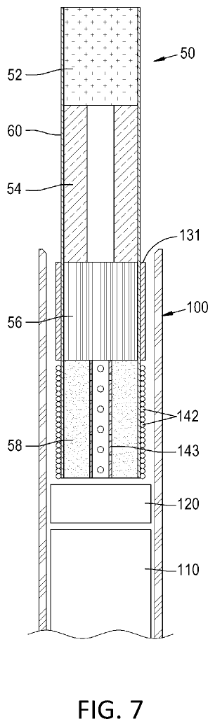

FIG. 7 schematically shows a cross-section of a complex heating type aerosol generating device combined with a resistance heater as a first heating means and an induction heater as a second heating means according to a second embodiment, to which the smoking article is applied.

The components of the smoking article 50 are identical to those in the first embodiment. The complex heating type aerosol generating device 100 according to the second embodiment comprises a pipe heater 131 as a first heating means for generating an aerosol by heating a liquid composition absorbed by the liquid cartridge 56, and an excitation coil 142 and a susceptor which reacts with the excitation coil 142 so that induction heating occurs due to eddy current losses to heat the tobacco filler 58 as a second heating means for generating an aerosol by heating the shredded tobacco in the tobacco filler 58. Additionally, the complex heating type aerosol generating device 100 comprises a battery 110 for supplying power to the pipe heater 131 and the excitation coil 142 and a control unit 120 configured to control the power supply to the pipe heater 131 and the excitation coil 142 from the battery 110.

The above-mentioned pipe heater 131 according to the second embodiment is a pipe with a heater line or planar heating element pattern printed or provided on the outside. The pipe heater 131 has a temperature sensor pattern so as to sense the temperature and control the power supply to the pipe heater 131 according to the sensed value. The pipe heater 131 heats the liquid cartridge 56 of the smoking article 50 from the side of the liquid cartridge 56 so that an aerosol is generated as the liquid composition soaking through or dampening the liquid cartridge 56 is heated.

Here, the susceptor is a hollow pipe 143 attached to the center of the tobacco filler 58, which is heated to a temperature of 400° C. or lower by induction heating due to eddy current losses, by reaction with the excitation coil 142. A cavity formed in the hollow pipe 143 is used as an airflow path. The susceptor may be heated to a temperature of 1,000° C. or higher depending on the magnitude of the alternating current applied to the excitation coil 142, whereas, in the present invention, the susceptor functioning as a heating element is heated to a temperature of 400° C. or lower, as stated above. The hollow pipe 143 heats the tobacco filler 58 from the center of the tobacco filler 58 to generate an aerosol from the shredded tobacco in the tobacco filler 58. The hollow pipe 143 may be made of one material selected from stainless steel, nickel, and cobalt or may be plated with one material selected from stainless steel, nickel, and cobalt, and, in some cases, the plating may produce a better effect.

The first heating means and the second heating means may heat the aerosol-forming substrate within a temperature range of 150 to 350° C. to generate an aerosol. The generated aerosol is inhaled through the mouth of the user via the paper tube 54 and the filter 52. In an example, the excitation coil 142 and the susceptor may heat the shredded tobacco in the tobacco filler 58 within a second temperature range of 150 to 250° C. to generate an aerosol derived from the shredded tobacco, and the pipe heater 131 may heat the absorbent in the liquid cartridge 56 within a first temperature range of 250 to 350° C. to generate an aerosol derived from the liquid composition in the absorbent. The above temperature conditions may be reversed. In addition, the second temperature range may overlap with the first temperature range at least in sections. Within the above temperature range, the wrapping paper is not combusted but may be partially scorched.

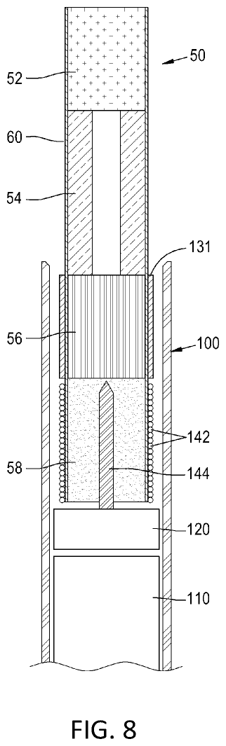

FIG. 8 schematically shows a cross-section of a complex heating type aerosol generating device combined with a resistance heater as a first heating means and an induction heater as a second heating means according to a third embodiment, to which the smoking article is applied.

The components of the smoking article 50 are identical to those in the foregoing embodiment. The complex heating type aerosol generating device 100 according to the third embodiment comprises a pipe heater 131 as a first heating means for generating an aerosol by heating a liquid composition absorbed by the liquid cartridge 56, and an excitation coil 142 and a susceptor which reacts with the excitation coil 142 so that induction heating occurs due to eddy current losses to heat the tobacco filler 58 as a second heating means for generating an aerosol by heating the shredded tobacco in the tobacco filler 58. Additionally, the complex heating type aerosol generating device 100 comprises a battery 110 for supplying power to the pipe heater 131 and the excitation coil 142 and a control unit 120 configured to control the power supply to the pipe heater 131 and the excitation coil 142 from the battery 110.

The above-mentioned pipe heater 131 according to the third embodiment is a pipe with a heater line or planar heating element pattern printed or provided on the outside. The pipe heater 131 has a temperature sensor pattern so as to sense the temperature and control the power supply to the pipe heater 131 according to the sensed value. The pipe heater 131 heats the liquid cartridge 56 of the smoking article 50 from the side of the liquid cartridge 56 so that an aerosol is generated as the liquid composition soaking through or dampening the liquid cartridge 56 is heated.

Here, the susceptor is a heat blade 144 that is inserted through the lower center of the smoking article 50 inserted into the cavity and makes direct contact with the tobacco filler 58 as the second aerosol-forming substrate in the smoking article 50, which is heated to a temperature of 400° C. or lower by induction heating due to eddy current losses, by reaction with the excitation coil 142. The susceptor may be heated to a temperature of 1,000° C. or higher depending on the magnitude of the alternating current applied to the excitation coil 142, whereas, in the present invention, the susceptor functioning as a heating element is heated to a temperature of 400° C. or lower, as stated above. The heat blade 144 is inserted through the tobacco filler 58 and heats the tobacco filler 58 from the center of the tobacco filler 58 to generate an aerosol from the shredded tobacco in the tobacco filler 58.

The first heating means and the second heating means may heat the aerosol-forming substrate within a temperature range of 150 to 350° C. to generate an aerosol. The generated aerosol is inhaled through the mouth of the user via the paper tube 54 and the filter 52. In an example, the excitation coil 142 and the susceptor may heat the shredded tobacco in the tobacco filler 58 within a second temperature range of 150 to 250° C. to generate an aerosol derived from the shredded tobacco, and the pipe heater 131 may heat the absorbent in the liquid cartridge 56 within a first temperature range of 250 to 350° C. to generate an aerosol derived from the liquid composition in the absorbent. The above temperature conditions may be reversed. In addition, the second temperature range may overlap with the first temperature range at least in sections. Within the above temperature range, the wrapping paper is not combusted but may be partially scorched.

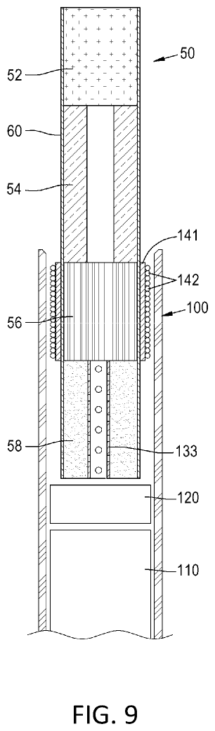

FIG. 9 schematically shows a cross-section of a complex heating type aerosol generating device combined with an induction heater as a first heating means and a resistance heater as a second heating means according to a fourth embodiment, to which the smoking article is applied.

The components of the smoking article 50 are identical to those in the foregoing embodiment.

The complex heating type aerosol generating device 100 according to the fourth embodiment comprises an excitation coil 142 and a susceptor which reacts with the excitation coil 142 so that induction heating occurs due to eddy current losses to heat the liquid cartridge 56 as a first heating means for generating an aerosol by heating a liquid composition absorbed by the liquid cartridge 56, and a hollow pipe 133 as a second heating means for generating an aerosol by heating the shredded tobacco in the tobacco filler 58.

Additionally, the complex heating type aerosol generating device 100 comprises a battery 110 for supplying power to the excitation coil 142 and the hollow pipe 133 and a control unit 120 configured to control the power supply to the excitation coil 142 and the hollow pipe 133 from the battery 110.

The above-mentioned susceptor according to the fourth embodiment is a metal heat pipe 141 provided inside the excitation coil 142 to be surrounded by the excitation coil 142, which is heated to a temperature of 400° C. or lower by induction heating due to eddy current losses, by reaction with the excitation coil 142. The susceptor may be heated to a temperature of 1,000° C. or higher depending on the magnitude of the alternating current applied to the excitation coil 142, whereas, in the present invention, the susceptor functioning as a heating element is heated to a temperature of 400° C. or lower, as stated above. The heat pipe 141 heats the liquid cartridge 56 from the side of the liquid cartridge 56 so that an aerosol is generated as the liquid composition soaking through or dampening the liquid cartridge 56 is heated. Here, the hollow pipe 133 is a resistance heater attached to the center of the tobacco filler 58, which heats the tobacco filler 58 from the center of the tobacco filler 58 to generate an aerosol from the shredded tobacco in the tobacco filler 58. The hollow pipe 133 may be made of one material selected from stainless steel, nickel, and cobalt or may be plated with one material selected from stainless steel, nickel, and cobalt, and, in some cases, the plating may produce a better effect.

The first heating means and the second heating means may heat the aerosol-forming substrate within a temperature range of 150 to 350° C. to generate an aerosol. The generated aerosol is inhaled through the mouth of the user via the paper tube 54 and the filter 52.

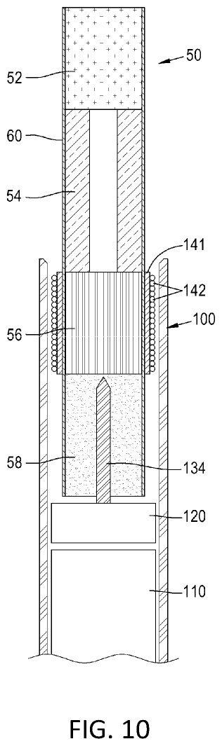

FIG. 10 schematically shows a cross-section of a complex heating type aerosol generating device combined with an induction heater as a first heating means and a resistance heater as a second heating means according to a fifth embodiment, to which the smoking article is applied.

The components of the smoking article 50 are identical to those in the foregoing embodiment.

The complex heating type aerosol generating device 100 according to the fifth embodiment comprises an excitation coil 142 and a susceptor which reacts with the excitation coil 142 so that induction heating occurs due to eddy current losses to heat the liquid cartridge 56 as a first heating means for generating an aerosol by heating a liquid composition absorbed by the liquid cartridge 56, and an invasive heater 134 as a second heating means for generating an aerosol by heating the shredded tobacco in the tobacco filler 58.

Additionally, the complex heating type aerosol generating device 100 comprises a battery 110 for supplying power to the excitation coil 142 and the invasive heater 134 and a control unit 120 configured to control the power supply to the excitation coil 142 and the invasive heater 134 from the battery 110.

The above-mentioned susceptor according to the fifth embodiment is a metal heat pipe 141 provided inside the excitation coil 142 to be surrounded by the excitation coil 142, which is heated to a temperature of 400° C. or lower by induction heating due to eddy current losses, by reaction with the excitation coil 142. The susceptor may be heated to a temperature of 1,000° C. or higher depending on the magnitude of the alternating current applied to the excitation coil 142, whereas, in the present invention, the susceptor functioning as a heating element is heated to a temperature of 400° C. or lower, as stated above. The heat pipe 141 heats the liquid cartridge 56 from the side of the liquid cartridge 56 so that an aerosol is generated as the liquid composition soaking through or dampening the liquid cartridge 56 is heated. Here, the invasive heater 134 is a resistance heater, which is inserted through the tobacco filler 58 and heats the tobacco filler 58 from the center of the tobacco filler 58 to generate an aerosol from the shredded tobacco in the tobacco filler 58.

The first heating means and the second heating means may heat the aerosol-forming substrate within a temperature range of 150 to 350° C. to generate an aerosol. The generated aerosol is inhaled through the mouth of the user via the paper tube 54 and the filter 52.

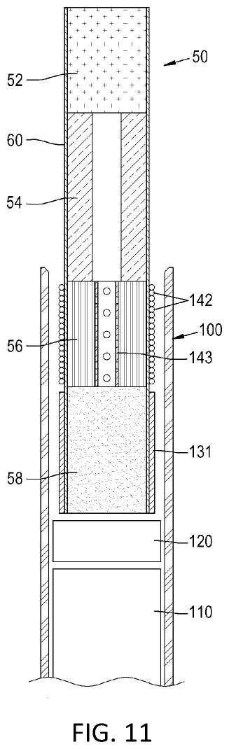

FIG. 11 schematically shows a cross-section of a complex heating type aerosol generating device combined with an induction heater as a first heating means and a resistance heater as a second heating means according to a sixth embodiment, to which the smoking article is applied.

The components of the smoking article 50 are identical to those in the foregoing embodiment.

The complex heating type aerosol generating device 100 according to the sixth embodiment comprises an excitation coil 142 and a susceptor which reacts with the excitation coil 142 so that induction heating occurs due to eddy current losses to heat the liquid cartridge 56 as a first heating means for generating an aerosol by heating a liquid composition absorbed by the liquid cartridge 56, and a pipe heater 131 as a second heating means for generating an aerosol by heating the shredded tobacco in the tobacco filler 58.

Additionally, the complex heating type aerosol generating device 100 comprises a battery 110 for supplying power to the excitation coil 142 and the pipe heater 131 and a control unit 120 configured to control the power supply to the excitation coil 142 and the pipe heater 131 from the battery 110.

The above-mentioned susceptor according to the sixth embodiment is a hollow pipe 143 attached to the center of the liquid cartridge 56, which is heated to a temperature of 400° C. or lower by induction heating due to eddy current losses, by reaction with the excitation coil 142. A hollow space defined in the hollow pipe 143 is used as an airflow path. The susceptor may be heated to a temperature of 1,000° C. or higher depending on the magnitude of the alternating current applied to the excitation coil 142, whereas, in the present invention, the susceptor functioning as a heating element is heated to a temperature of 400° C. or lower, as stated above. The hollow pipe 143 may be made of one material selected from stainless steel, nickel, and cobalt or may be plated with one material selected from stainless steel, nickel, and cobalt, and, in some cases, the plating may produce a better effect.

Here, the pipe heater 131 is a pipe with a heater line or planar heating element pattern printed or provided on the outside. The pipe heater 131 has a temperature sensor pattern so as to sense the temperature and control the power supply to the pipe heater 131 according to the sensed value. The pipe heater 131 heats the tobacco filler 58 from the side of the tobacco filler 58 to generate an aerosol from the shredded tobacco in the tobacco filler 58.

The first heating means and the second heating means may heat the aerosol-forming substrate within a temperature range of 150 to 350° C. to generate an aerosol. The generated aerosol is inhaled through the mouth of the user via the paper tube 54 and the filter 52.

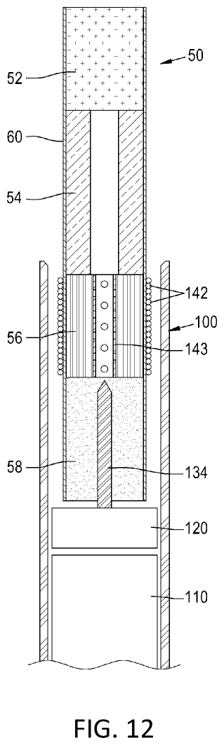

FIG. 12 schematically shows a cross-section of a complex heating type aerosol generating device combined with an induction heater as a first heating means and a resistance heater as a second heating means according to a seventh embodiment, to which the smoking article is applied.

The components of the smoking article 50 are identical to those in the foregoing embodiment.

The complex heating type aerosol generating device 100 according to the seventh embodiment comprises an excitation coil 142 and a susceptor which reacts with the excitation coil 142 so that induction heating occurs due to eddy current losses to heat the liquid cartridge 56 as a first heating means for generating an aerosol by heating a liquid composition absorbed by the liquid cartridge 56, and an invasive heater 134 as a second heating means for generating an aerosol by heating the shredded tobacco in the tobacco filler 58.

Additionally, the complex heating type aerosol generating device 100 comprises a battery 110 for supplying power to the excitation coil 142 and the invasive heater 134 and a control unit 120 configured to control the power supply to the excitation coil 142 and the invasive heater 134 from the battery 110.

The above-mentioned susceptor according to the seventh embodiment is a hollow pipe 143 attached to the center of the liquid cartridge 56, which is heated to a temperature of 400° C. or lower by induction heating due to eddy current losses, by reaction with the excitation coil 142. A hollow space defined in the hollow pipe 143 is used as an airflow path. The susceptor may be heated to a temperature of 1,000° C. or higher depending on the magnitude of the alternating current applied to the excitation coil 142, whereas, in the present invention, the susceptor functioning as a heating element is heated to a temperature of 400° C. or lower, as stated above. The hollow pipe 143 may be made of one material selected from stainless steel, nickel, and cobalt or may be plated with one material selected from stainless steel, nickel, and cobalt, and, in some cases, the plating may produce a better effect.

Here, the invasive heater 134 is a resistance heater, which is inserted through the tobacco filler 58 and heats the tobacco filler 58 from the center of the tobacco filler 58 to generate an aerosol from the shredded tobacco in the tobacco filler 58.

The first heating means and the second heating means may heat the aerosol-forming substrate within a temperature range of 150 to 350° C. to generate an aerosol. The generated aerosol is inhaled through the mouth of the user via the paper tube 54 and the filter 52.

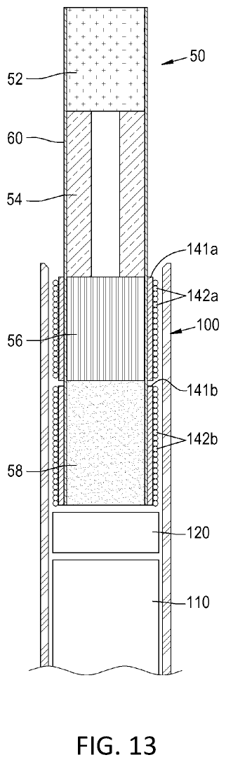

FIG. 13 schematically shows a cross-section of a complex heating type aerosol generating device combined with an induction heater as a first heating means and an induction heater as a second heating means according to an eighth embodiment, to which the smoking article is applied.

The components of the smoking article 50 are identical to those in the foregoing embodiment.

The complex heating type aerosol generating device 100 according to the eighth embodiment comprises an excitation coil 142a and a heat pipe 141a as a susceptor which reacts with the excitation coil 142a so that induction heating occurs due to eddy current losses to heat the liquid cartridge 56 as a first heating means corresponding to the liquid cartridge 56, and an excitation coil 142b and a heat pipe 141b as a susceptor which reacts with the excitation coil 142b so that induction heating occurs due to eddy current losses to heat the tobacco filler 58 as a second heating means corresponding to the tobacco filler 58.

The heat pipe 141a heats the liquid cartridge 56 of the smoking article 50 from the side of the liquid cartridge 56 so that an aerosol is generated from the liquid composition soaking through or dampening the liquid cartridge 56, and the heat pipe 141b heats the tobacco filler 58 of the smoking article 50 from the side of the tobacco filler 58 so that an aerosol is generated from the shredded tobacco in the tobacco filler 58. The heat pipes 141a and 141b of the eighth embodiment allow the liquid cartridge 56 and the tobacco filler 58 to be heated to different temperatures. The target temperature may be within a temperature range of 150 to 350° C., and may be adjusted according to the sensed temperature. The generated aerosol is inhaled through the mouth of the user via the paper tube 54 and the filter 52. In an example, the heat pipe 141b may heat the shredded tobacco in the tobacco filler 58 within a second temperature range of 150 to 250° C. to generate an aerosol derived from the shredded tobacco, and the heat pipe 141a may heat the absorbent in the liquid cartridge 56 within a first temperature range of 250 to 350° C. to generate an aerosol derived from the liquid composition in the absorbent. The above temperature conditions may be reversed. In addition, the second temperature range may overlap with the first temperature range at least in sections. Within the above temperature range, the wrapping paper is not combusted but may be partially scorched.

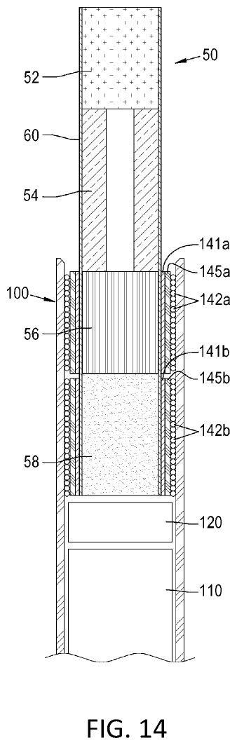

FIG. 14 schematically shows a cross-section of a complex heating type aerosol generating device combined with an induction heater as a first heating means and an induction heater as a second heating means according to a ninth embodiment, to which the smoking article is applied.

The complex heating type aerosol generating device 100 according to the ninth embodiment of the present invention has the same construction as the above-described eighth embodiment, with the addition of an insulating part 145a between the excitation coil 142a and the heat pipe 141a and an insulating part 145b between the excitation coil 142b and the heat pipe 141b.

Placing the insulating parts 145a and 145b between the excitation coils 142a and 142b and the heat pipes 141a and 141b can prevent induction heat generated in the heat pipes 141a and 141b and the smoking article 50 from being transferred to the excitation coils 142a and 142b. The insulating parts 145a and 145b may be insulating pipes that have the shape of a pipe into which the smoking article 50 is inserted. If intense heat generated in the heat pipes 141a and 141b is transferred to the excitation coils 142a and 142b, it increases the resistance of the excitation coils 142a and 142b themselves, which, in turn, reduces the strength of the magnetic field induced by the excitation coils 142a and 142b and then reduces the amount of induction heat generated in the heat pipes 141a and 141b. Thus, placing the insulating parts 145a and 145b between the excitation coils 142a and 142b and the heat pipes 141a and 141b improves the amount of induction heat generated in the heat pipes 141a and 141b. In addition, there is less energy loss, which makes it possible to easily control the heating temperature of the heat pipes 141a and 141b.

An insulating film using a filler having an insulating and shielding function may be attached to the outer wall of the insulating parts 145a and 145b applied for insulation, to improve insulation efficiency of the insulating parts 145a and 145b. Examples of the insulating filler may include ceramic powder such as zirconia having low thermal conductivity, and ceramic powder such as porous silica gel, porous alumina, and aerogel.

Alternatively, an insulating paint using a filler having an insulating and shielding function may be applied to the outer wall of the insulating parts 145a and 145b applied for insulation, to improve insulation efficiency of the insulator. Examples of the insulating filler may include ceramic powder such as zirconia having low thermal conductivity, and ceramic powder such as porous silica gel, porous alumina, and aerogel.

In other embodiments in which the complex heating type aerosol generating device 100 according to the present invention has an induction heater, the above-described insulating part 145a and 145b may be likewise provided between the excitation coil and the susceptor.

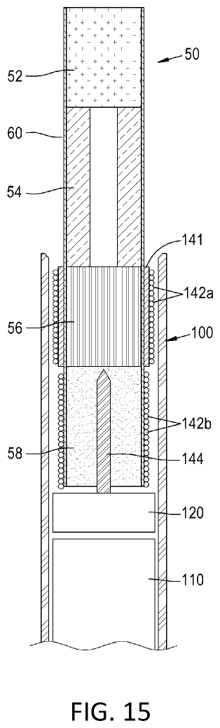

FIG. 15 schematically shows a cross-section of a complex heating type aerosol generating device combined with an induction heater as a first heating means and an induction heater as a second heating means according to a tenth embodiment, to which the smoking article is applied.

The components of the smoking article 50 are identical to those in the foregoing embodiment.

The complex heating type aerosol generating device 100 according to the tenth embodiment comprises an excitation coil 142a and a heat pipe 141 as a susceptor which reacts with the excitation coil 142a so that induction heating occurs due to eddy current losses to heat the liquid cartridge 56 as a first heating means corresponding to the liquid cartridge 56, and an excitation coil 142b and a heat blade 144 as a susceptor which reacts with the excitation coil 142b so that induction heating occurs due to eddy current losses to heat the tobacco filler 58 as a second heating means corresponding to the tobacco filler 58.

The heat pipe 141 heats the liquid cartridge 56 of the smoking article 50 from the side of the liquid cartridge 56 to generate an aerosol from the liquid composition soaking through or dampening the liquid cartridge 56. The heat blade 144 is inserted through the tobacco filler 58 and heats the tobacco filler 58 from the center of the tobacco filler 58 to generate an aerosol from the shredded tobacco in the tobacco filler 58.

That is, the heat pipe 141 and heat blade 144 of the tenth embodiment allow the liquid cartridge 56 and the tobacco filler 58 to be heated to different temperatures. The target temperature may be within a temperature range of 150 to 350° C., and may be adjusted according to the sensed temperature. The generated aerosol is inhaled through the mouth of the user via the paper tube 54 and the filter 52. In an example, the heat blade 144 may heat the shredded tobacco in the tobacco filler 58 within a second temperature range of 150 to 250° C. to generate an aerosol derived from the shredded tobacco, and the heat pipe 141 may heat the absorbent in the liquid cartridge 56 within a first temperature range of 250 to 350° C. to generate an aerosol derived from the liquid composition in the absorbent. The above temperature conditions may be reversed. In addition, the second temperature range may overlap with the first temperature range at least in sections. Within the above temperature range, the wrapping paper is not combusted but may be partially scorched.

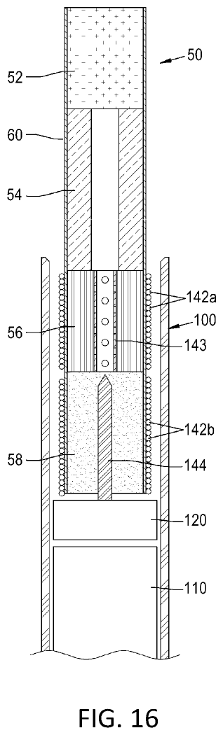

FIG. 16 schematically shows a cross-section of a complex heating type aerosol generating device combined with an induction heater as a first heating means and an induction heater as a second heating means according to an eleventh embodiment, to which the smoking article is applied.

The components of the smoking article 50 are identical to those in the foregoing embodiment.

The complex heating type aerosol generating device 100 according to the eleventh embodiment comprises an excitation coil 142a and a hollow pipe 143 as a susceptor which reacts with the excitation coil 142a so that induction heating occurs due to eddy current losses to heat the liquid cartridge 56 as a first heating means corresponding to the liquid cartridge 56, and an excitation coil 142b and a heat blade 144 as a susceptor which reacts with the excitation coil 142b so that induction heating occurs due to eddy current losses to heat the tobacco filler 58 as a second heating means corresponding to the tobacco filler 58.

The hollow pipe 143 heats the liquid cartridge 56 of the smoking article 50 from the center of the liquid cartridge 56 to generate an aerosol from the liquid composition soaking through or dampening the liquid cartridge 56, and the heat blade 144 is inserted through the tobacco filler 58 and heats the tobacco filler 58 from the center of the tobacco filler 58 to generate an aerosol from the shredded tobacco in the tobacco filler 58. A hollow space defined in the hollow pipe 143 is used as an airflow path. The hollow pipe 143 may be made of one material selected from stainless steel, nickel, and cobalt or may be plated with one material selected from stainless steel, nickel, and cobalt, and, in some cases, the plating may produce a better effect.

The hollow pipe 143 and heat blade 144 of the eleventh embodiment allow the liquid cartridge 56 and the tobacco filler 58 to be heated to different temperatures. The target temperature may be within a temperature range of 150 to 350° C., and may be adjusted according to the sensed temperature. The generated aerosol is inhaled through the mouth of the user via the paper tube 54 and the filter 52. In an example, the heat blade 144 may heat the shredded tobacco in the tobacco filler 58 within a second temperature range of 150 to 250° C. to generate an aerosol derived from the shredded tobacco, and the hollow pipe 143 may heat the absorbent in the liquid cartridge 56 within a first temperature range of 250 to 350° C. to generate an aerosol derived from the liquid composition in the absorbent. The above temperature conditions may be reversed. In addition, the second temperature range may overlap with the first temperature range at least in sections. Within the above temperature range, the wrapping paper is not combusted but may be partially scorched.

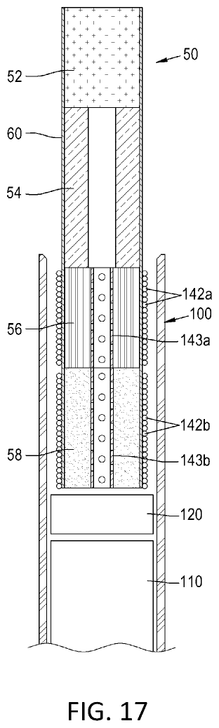

FIG. 17 schematically shows a cross-section of a complex heating type aerosol generating device combined with an induction heater as a first heating means and an induction heater as a second heating means according to a twelfth embodiment, to which the smoking article is applied.

The components of the smoking article 50 are identical to those in the foregoing embodiment.

The complex heating type aerosol generating device 100 according to the twelfth embodiment comprises an excitation coil 142a and a hollow pipe 143a as a susceptor which reacts with the excitation coil 142a so that induction heating occurs due to eddy current losses to heat the liquid cartridge 56 as a first heating means corresponding to the liquid cartridge 56, and an excitation coil 142b and a hollow pipe 143b as a susceptor which reacts with the excitation coil 142b so that induction heating occurs due to eddy current losses to heat the tobacco filler 58 as a second heating means corresponding to the tobacco filler 58.

The hollow pipe 143a heats the liquid cartridge 56 of the smoking article 50 from the center of the liquid cartridge 56 to generate an aerosol from the liquid composition soaking through or dampening the liquid cartridge 56, and the hollow pipe 143b heats the tobacco filler 58 from the center of the tobacco filler 58 to generate an aerosol from the shredded tobacco in the tobacco filler 58. Hollow spaces defined in the hollow pipes 143a and 143b are used as airflow paths. The hollow pipes 143a and 143b may be made of one material selected from stainless steel, nickel, and cobalt or may be plated with one material selected from stainless steel, nickel, and cobalt, and, in some cases, the plating may produce a better effect.

The hollow pipe 143a and hollow pipe 143b of the twelfth embodiment allow the liquid cartridge 56 and the tobacco filler 58 to be heated to different temperatures. The target temperature may be within a temperature range of 150 to 350° C., and may be adjusted according to the sensed temperature. The generated aerosol is inhaled through the mouth of the user via the paper tube 54 and the filter 52. In an example, the hollow pipe 143b may heat the shredded tobacco in the tobacco filler 58 within a second temperature range of 150 to 250° C. to generate an aerosol derived from the shredded tobacco, and the hollow pipe 143a may heat the absorbent in the liquid cartridge 56 within a first temperature range of 250 to 350° C. to generate an aerosol derived from the liquid composition in the absorbent. The above temperature conditions may be reversed. In addition, the second temperature range may overlap with the first temperature range at least in sections. Within the above temperature range, the wrapping paper is not combusted but may be partially scorched.

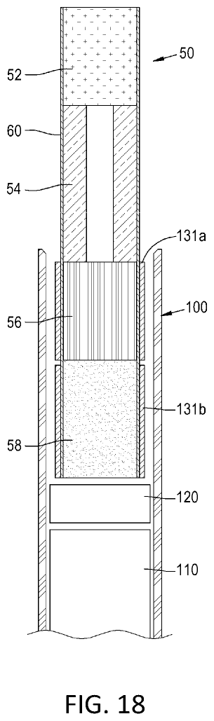

FIG. 18 schematically shows a cross-section of a complex heating type aerosol generating device combined with a resistance heater as a first heating means and a resistance heater as a second heating means according to a thirteenth embodiment, to which the smoking article is applied

The components of the smoking article 50 are identical to those in the foregoing embodiment.

The complex heating type aerosol generating device 100 according to the thirteenth embodiment comprises a resistance pipe heater 131a as a first heating means corresponding to the liquid cartridge 56, and a resistance pipe heater 131b as a second heating means corresponding to the tobacco filler 58. Like the pipe heaters according to the above-described embodiments, the resistance pipe heaters 131a and 131b are pipes with a heater line or planar heating element pattern printed or provided on the outside. The resistance pipe heaters 131a and 131b according to the thirteenth embodiment likewise have a temperature sensor pattern so as to sense the temperature and control the power supply to the pipe heaters 131a and 131b according to the sensed value. The pipe heater 131a heats the liquid cartridge 56 of the smoking article 50 from the side of the liquid cartridge 56 so that an aerosol is generated from the liquid composition soaking through or dampening the liquid cartridge 56, and the pipe heater 131b heats the tobacco filler 58 of the smoking article 50 from the side of the tobacco filler 58 so that an aerosol is generated from the shredded tobacco in the tobacco filler 58. The pipe heaters 131a and 131b of the thirteenth embodiment allow the liquid cartridge 56 and the tobacco filler 58 to be heated to different temperatures. The target temperature may be within a temperature range of 150 to 350° C., and may be adjusted according to the sensed temperature. The generated aerosol is inhaled through the mouth of the user via the paper tube 54 and the filter 52. In an example, the pipe heater 131b may heat the shredded tobacco in the tobacco filler 58 within a second temperature range of 150 to 250° C. to generate an aerosol derived from the shredded tobacco, and the pipe heater 131a may heat the absorbent in the liquid cartridge 56 within a first temperature range of 250 to 350° C. to generate an aerosol derived from the liquid composition in the absorbent. The above temperature conditions may be reversed. In addition, the second temperature range may overlap with the first temperature range at least in sections. Within the above temperature range, the wrapping paper is not combusted but may be partially scorched.

By employing the construction of the thirteenth embodiment, it is possible to properly generate an aerosol from the liquid cartridge 56 and the tobacco filler 58, in a smoking article that has the construction shown in the drawing, or in a smoking article in which the relative positions of the liquid cartridge 56 and tobacco filler 58 are reversed, without problems with the invasive heater (such as having residues coming off from the electrically heated smoking article after use or not being easily inserted into the liquid cartridge), and it is also possible to set and control the temperatures of the pipe heaters 131a and 131b to an optimum temperature for each aerosol-forming substrate to generate an aerosol.

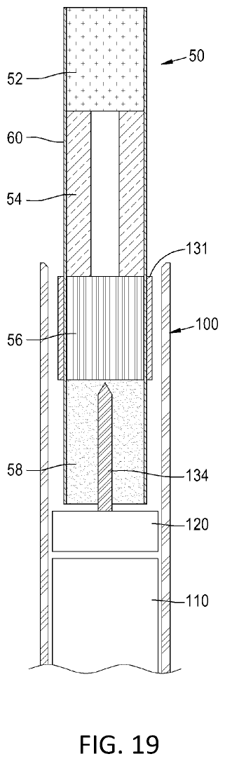

FIG. 19 schematically shows a cross-section of a complex heating type aerosol generating device combined with a resistance heater as a first heating means and a resistance heater as a second heating means according to a fourteenth embodiment, to which the smoking article is applied.

The components of the smoking article 50 are identical to those in the foregoing embodiment.

The complex heating type aerosol generating device 100 according to the fourteenth embodiment comprises a resistance pipe heater 131 as a first heating means corresponding to the liquid cartridge 56, and a resistance invasive heater 134 as a second heating means corresponding to the tobacco filler 58. Like the pipe heaters according to the above-described embodiments, the pipe heater 131 is a pipe with a heater line or planar heating element pattern printed or provided on the outside.

The pipe heater 131 according to the fourteenth embodiment likewise has a temperature sensor pattern so as to sense the temperature and control the power supply to the pipe heater 131 according to the sensed value. The pipe heater 131 heats the liquid cartridge 56 of the smoking article 50 from the side of the liquid cartridge 56 to generate an aerosol from the liquid composition soaking through or dampening the liquid cartridge 56, and the invasive heater 134 is a resistance heater, which is inserted through the tobacco filler 58 and heats the tobacco filler 58 from the center of the tobacco filler 58 to generate an aerosol from the shredded tobacco in the tobacco filler 58.

The pipe heater 131 and the invasive heater 134 of the fourteenth embodiment allow the liquid cartridge 56 and the tobacco filler 58 to be heated to different temperatures. The target temperature may be within a temperature range of 150 to 350° C., and may be adjusted according to the sensed temperature. The generated aerosol is inhaled through the mouth of the user via the paper tube 54 and the filter 52. In an example, the invasive heater 134 may heat the shredded tobacco in the tobacco filler 58 within a second temperature range of 150 to 250° C. to generate an aerosol derived from the shredded tobacco, and the pipe heater 131 may heat the absorbent in the liquid cartridge 56 within a first temperature range of 250 to 350° C. to generate an aerosol derived from the liquid composition in the absorbent. The above temperature conditions may be reversed. In addition, the second temperature range may overlap with the first temperature range at least in sections. Within the above temperature range, the wrapping paper is not combusted but may be partially scorched.

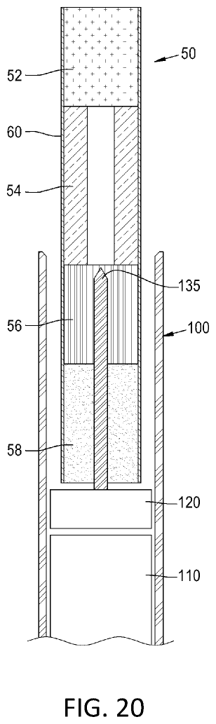

FIG. 20 schematically shows a cross-section of a complex heating type aerosol generating device having a single resistance heater as a first heating means and a second heating means according to a fifteenth embodiment, to which the smoking article is applied.

The components of the smoking article 50 are identical to those in the foregoing embodiment.

The complex heating type aerosol generating device 100 according to the fifteenth embodiment comprises one invasive heater 135 as first and second heating means corresponding to the liquid cartridge 56 and the tobacco filler 58. The invasive heater 135 is a resistance heater, which is inserted through the tobacco filler 58 and the liquid cartridge 56 and heats the tobacco filler 58 to generate an aerosol from the shredded tobacco in the tobacco filler 58 and heats the liquid cartridge 56 of the smoking article 50 from the center of the liquid cartridge 50 to generate an aerosol from the liquid composition soaking through or dampening the liquid cartridge 56.

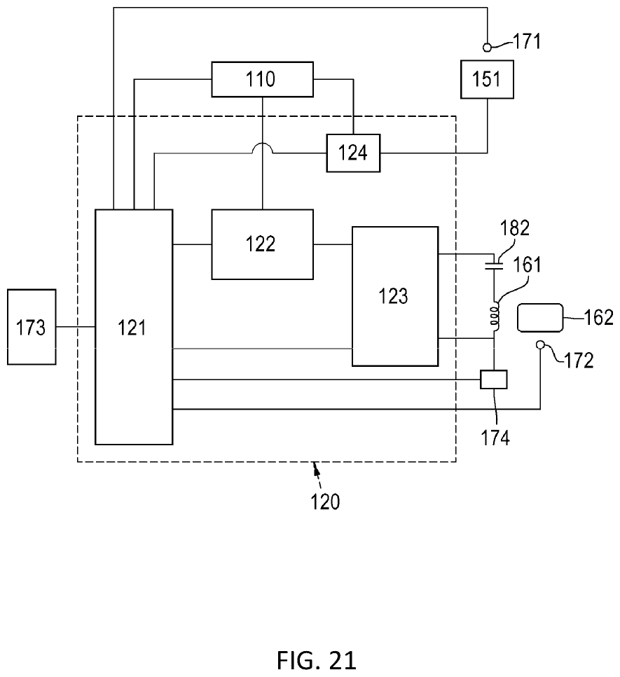

FIG. 21 is a block diagram showing an embodiment of temperature controlling and heating time controlling in the complex heating type aerosol generating device combined with a resistance heater and an induction heater according to the present invention.

Referring to FIG. 21, in the complex heating type aerosol generating device according to the present invention, which is combined with a resistance heater and an induction heater, the control unit 120 comprises a microcontroller 121, a power boosting circuit 122, an induction logic 123, and a heater driver 124. The microcontroller 121 supplies power to the resistance heater 151 from the battery 110 by controlling the heater driver 124. In some embodiments, the heater driver 124 is an FET, which is turned on or off in response to a PWM signal output from the microcontroller 121 to regulate the power supplied to the resistance heater 151 from the battery 110. Moreover, a temperature sensor 171 is installed at or near the resistance heater 151—for example, the temperature sensor 171 may be the above-mentioned temperature sensor pattern provided on the pipe heater 131. The microcontroller 121 regulates the power supplied to the resistance heater 151 from the battery 110 by controlling the PWM signal fed to the heater driver 124 in response to a signal received from the temperature sensor 171, whereby the temperature of the resistance heater 151 is controlled.

In addition, an excitation coil 161 and a susceptor 162 are provided as an induction heater. The microcontroller 121 controls the power boosting circuit 122 so that the power boosting circuit 122 amplifies a direct current voltage supplied from the battery 110 for induction heating and supplies a direct current to the induction logic 123. The power boosting circuit 122 is adopted for stable power supply to heat the susceptor 162 by induction heating when the battery 110 is used as a power source for induction heating. The microcontroller 121 also feeds a PWM signal to the induction logic 123. The induction logic 123 performs a switching operation depending on the PWM signal received from the microcontroller 121 to convert the direct current supplied from the power boosting circuit 122 into an alternating current and supply it to the excitation coil 161 to heat the susceptor 162 by induction heating.

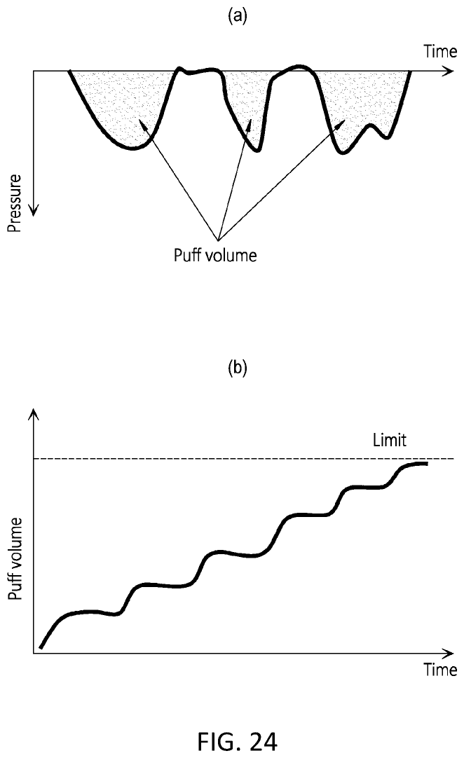

The complex heating type aerosol generating device 100 according to the present invention has a pressure sensor 173 at a predetermined position through which an airflow passes. The pressure sensor 173 senses a pressure change. Referring to FIG. 24, the pressure sensor 173 feeds a sensed value to the microcontroller 121 in response to a pressure change shown in (a) of FIG. 24, and the microcontroller 121 then calculates the integral value of puff volume based on the sensed value received from the pressure sensor 173, and, if the cumulative integral value reaches the limit of puff volume shown in (b) of FIG. 24, turns off the aforementioned PWM signal or cuts off the power from the battery 110, such that the operation of each of the resistance heater and induction heater is finished.

Furthermore, a temperature sensor 172 is installed at the susceptor 162 or near the susceptor 162. The temperature sensor 172 may feed a signal to the microcontroller 121 upon sensing a temperature of the susceptor 162. Then, the microcontroller 121 may adjust the frequency of a PWM signal depending on the required temperature and feed the PWM signal to the induction logic 123, and the induction logic 123 may supply an alternating current to the excitation coil 161 while adjusting frequency in response to the PWM signal transmitted from the microcontroller 121. In some embodiments, a sensor 174 may be installed which is electrically connected to the excitation coil 161 and measures inductance and feeds a signal of the measured inductance to the microcontroller 121. The microcontroller 121 compares the measured inductance with a preset inductance value in response to an input signal, and, if the inductance of the excitation coil 161 is out of a preset range, determines that an unusable cigarette or foreign material gets in and performs control to ensure that there is no heating. In some embodiments, the above-described sensor 174 is a sensor 174 capable of measuring the impedance of the excitation coil 161 and feeding a signal of the measured impedance to the microcontroller 121. The microcontroller 121 compares the measured impedance with a preset impedance value in response to an input signal, and, if the impedance of the excitation coil 161 is out of a preset range, determines that an unusable cigarette or foreign material gets in and performs control to ensure that there is no heating.

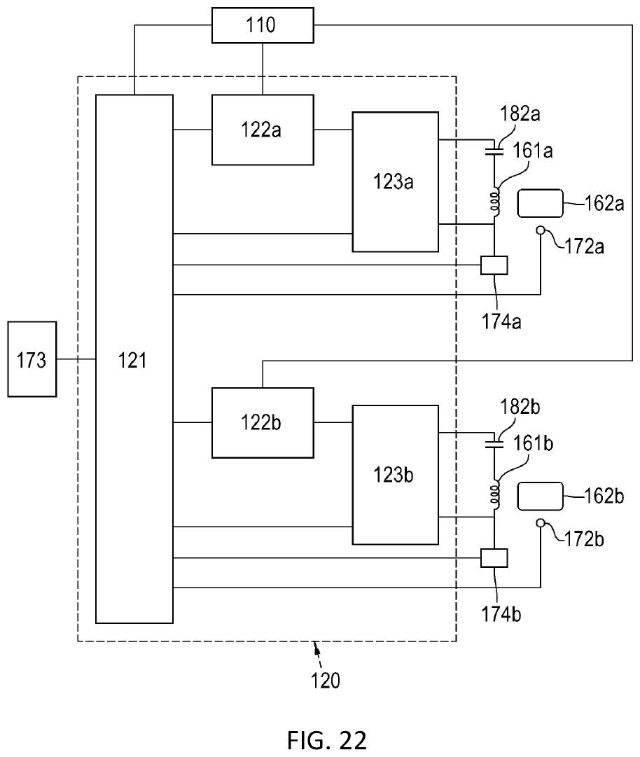

FIG. 22 is a block diagram showing an embodiment of temperature controlling and heating time controlling in the complex heating type aerosol generating device combined with two induction heaters according to the present invention.

In the complex heating type aerosol generating device 100 according to the present invention, which is combined with two induction heaters, the control unit 120 comprises a microcontroller 121, power boosting circuits 122a and 122b, and induction logics 123a and 123b.

The complex heating type aerosol generating device 100 according to the present invention, which is combined with two induction heaters, has an excitation coil 161a and a susceptor 162a as an induction heater and an excitation coil 161b and a susceptor 162b as another induction heater. The microcontroller 121 controls the power boosting circuits 122a and 122b corresponding to the respective induction heaters so that the power boosting circuits 122a and 122b amplify a direct current voltage supplied from the battery 110 for induction heating and supply a direct current to the induction logics 123a and 123b. The power boosting circuits 122a and 122b are adopted for stable power supply to heat the susceptors 162a and 162b by induction heating when the battery 110 is used as a power source for induction heating. The microcontroller 121 also feeds respective PWM signals to the induction logics 123a and 123b corresponding to the respective induction heaters. The induction logics 123a and 123b perform a switching operation depending on the PWM signals received from the microcontroller 121 to convert the direct current supplied from the power boosting circuits 122a and 122b into an alternating current and supply it to the excitation coils 161a and 161b to heat the susceptors 162a and 162b by induction heating. In the drawings, reference numerals 182a and 182b denote capacitors.

The complex heating type aerosol generating device 100 according to the present invention has a pressure sensor 173 at a predetermined position through which an airflow passes. The pressure sensor 173 senses a pressure change. Referring to FIG. 24, the pressure sensor 173 feeds a sensed value to the microcontroller 121 in response to a pressure change shown in (a) of FIG. 24, and the microcontroller 121 then calculates the integral value of puff volume based on the sensed value received from the pressure sensor 173, and, if the cumulative integral value reaches the limit of puff volume shown in (b) of FIG. 24, turns off the aforementioned PWM signals or controls the battery 110 to cut off the power applied to the power boosting circuits 122a and 122b, such that the operation of each of the respective induction heaters is finished.

Furthermore, temperature sensors 172a and 172b are installed at the susceptors 162a and 162b or near the susceptors 162a and 162b, respectively. The temperature sensors 172a and 172b may feed a signal to the microcontroller 121 upon sensing a temperature of the susceptors 162a and 162b, respectively. Then, the microcontroller 121 may adjust the frequency of respective PWM signals depending on the required temperature and feed the PWM signals to the induction logics 123a and 123b, respectively, and the induction logics 123a and 123b may supply an alternating current to the excitation coils 161a and 161b, respectively, while adjusting frequency in response to the PWM signals transmitted from the microcontroller 121. In some embodiments, inductance sensors 174a and 174b may be installed which are electrically connected to the excitation coils 161a and 161b, respectively, and measure inductance and feed a signal of the measured inductance to the microcontroller 121. The microcontroller 121 compares the measured inductance with a preset inductance value in response to an input signal, and, if the inductance of the excitation coil 161a and/or excitation coil 161b is out of a preset range, determines that an unusable cigarette or foreign material gets in and controls the battery 110 to cut off the power applied to the power boosting circuits 122a and 122a and therefore prevent heating. In some embodiments, the above-described sensors 174a and 174b are sensors 174a and 174b capable of measuring the impedance of the excitation coils 161a and 161b and feeding a signal of the measured impedance to the microcontroller 121. The microcontroller 121 compares the measured impedance with a preset impedance value in response to an input signal, and, if the impedance of the excitation coil 161a and/or excitation coil 161b is out of a preset range, determines that an unusable cigarette or foreign material gets in and performs control to ensure that there is no heating.

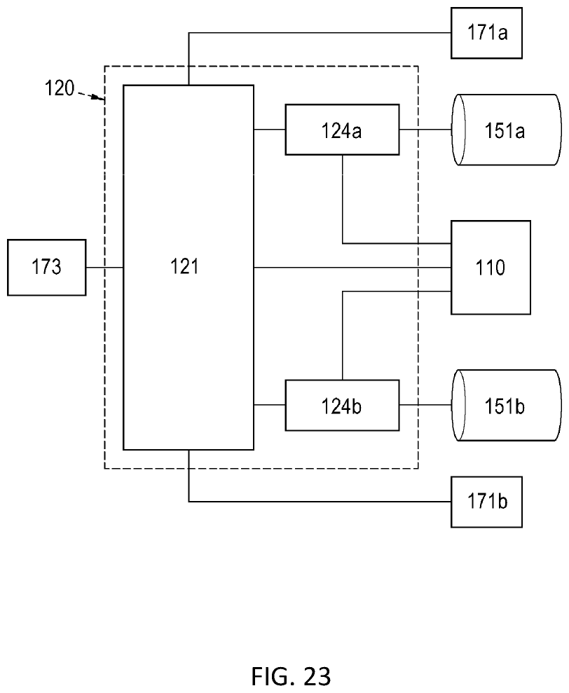

FIG. 23 is a block diagram showing an embodiment of temperature controlling and heating time controlling in the complex heating type aerosol generating device combined with two resistance heaters according to the present invention.

Referring to FIG. 23, in the complex heating type aerosol generating device 100 according to the present invention, which is combined with two resistance heaters, the control unit 120 comprises a microcontroller 121 and respective heater drivers 124a and 124b. The microcontroller 121 supplies power to the respective resistance heaters 151a and 151b from the battery 110 by controlling the respective heater drivers 124a and 124b. In some embodiments, the heater drivers 124a and 124b are FETs, which are turned on or off in response to respective PWM signals output from the microcontroller 121 to regulate the power supplied to the resistance heaters 151a and 151b from the battery 110. Moreover, temperature sensors 171a and 171b are installed at or near the resistance heaters 151a and 151b—for example, the temperature sensors 171a and 171b may be the above-mentioned temperature sensor pattern provided on the pipe heater 131. The microcontroller 121 regulates the power supplied to the resistance heaters 151a and 151b from the battery 110 by controlling the PWM signals fed to the heater drivers 124a and 124b in response to signals received from the temperature sensors 171a and 171b, whereby the temperatures of the resistance heaters 151a and 151b are controlled. In some embodiments, the microcontroller 121 regulates the power supplied to the resistance heaters 151a and 151b from the battery 110 by controlling the PWM signals fed to the heater drivers 124a and 124b in response to signals received from the temperature sensors 171a and 171b respectively installed at or near the resistance heaters 151a and 151b, whereby the temperatures of the resistance heaters 151a and 151b are controlled.

The complex heating type aerosol generating device 100 according to the present invention has a pressure sensor 173 at a predetermined position through which an airflow passes. The pressure sensor 173 senses a pressure change. Referring to FIG. 24, the pressure sensor 173 feeds a sensed value to the microcontroller 121 in response to a pressure change shown in (a) of FIG. 24, and the microcontroller 121 then calculates the integral value of puff volume based on the sensed value received from the pressure sensor 173, and, if the cumulative integral value reaches the limit of puff volume shown in (b) of FIG. 24, turns off the aforementioned PWM signal such that the operation of each of the resistance heaters is finished.

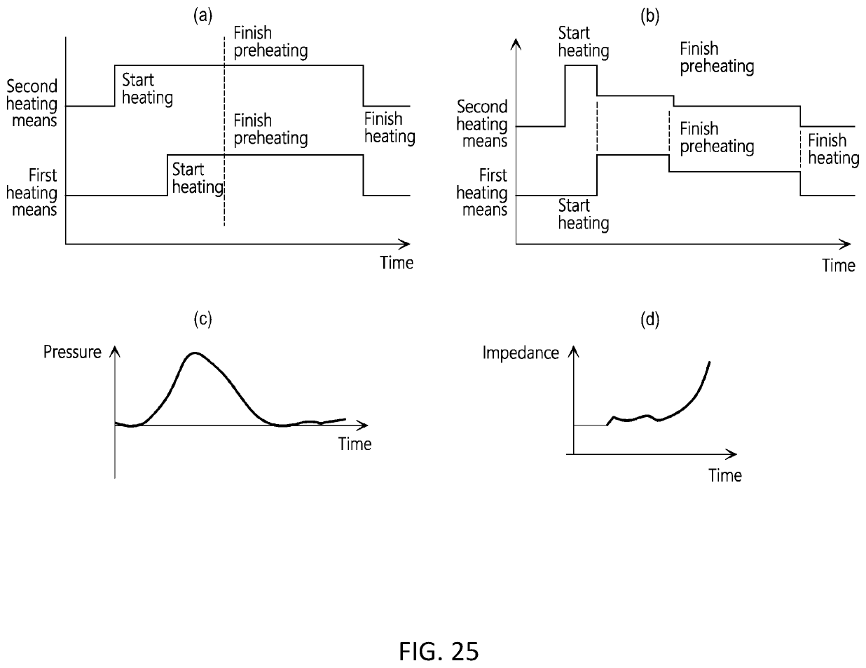

FIG. 25 is a graph showing an embodiment of temperature controlling and heating controlling in the complex heating type aerosol generating device according to the present invention.

Referring to (a) of FIG. 25, according to the embodiment, the above-described microcontroller 121 of the control unit 120 may heat a second heating means first by controlling the second heating means and then heat a first heating means later than the second heating means by controlling the first heating means, and may start heating the first heating means by controlling the first heating means before preheating of the second heating means is finished, in response to a signal sensed by a temperature sensor as a second sensor. The second heating means is for heating a second aerosol-forming substrate comprising a medium with a high heating temperature. Moreover, referring to (b) of FIG. 25, according to the embodiment, the microcontroller 121 of the control unit 120 may heat a second heating means first by controlling the second heating means in such a way that high power is applied from the battery 110 to get the heating done in a short time. In other words, the microcontroller 121 of the control unit 120 may regulate the power applied to the second heating means by reducing the equivalent power applied to the first heating means when heating the first heating means. The second heating means is for heating a second aerosol-forming substrate comprising a medium with a high heating temperature.

Referring to (c) of FIG. 25, the pressure sensor 173 senses a pressure change over time. Referring to (a) and (b) of FIG. 24, as described above, the microcontroller 121 of the control unit 120 calculates the integral value of puff volume based on the sensed value received from the pressure sensor 173. If the cumulative integral value reaches the limit of puff volume, the microcontroller 121 may indicate this to the user by an indicator (not shown) such as a display or LED, and may determine that the smoking article 50 is exhausted and then finish the heating by controlling the first heating means and the second heating means.

In some embodiments, the complex heating type aerosol generating device 100 has a sensor 174 electrically connected to the microcontroller 121, that is capable of measuring the impedance of the excitation coil used for induction heating of the susceptor heating the first aerosol-forming substrate or second aerosol-forming substrate. If the aerosol-forming substance of the aerosol-forming substrate is used up, the temperature of the susceptor rises and the impedance of the excitation coil goes up. Referring to (d) of FIG. 25, if impedance goes up instantaneously and abruptly, the microcontroller 121 may determine by a signal received from the sensor 174 that the aerosol-forming substance of the aerosol-forming substrate is used up, and indicate this by an indicator (not shown) such as a display or LED. Moreover, the impedance of the excitation coil also goes up abruptly when an exhausted smoking article 50 is inserted for heating. Thus, if the impedance goes up instantaneously and abruptly, the microcontroller 121 may determine by a signal received from the sensor 174 that the exhausted smoking article 50 is inserted, and indicate this by an indicator (not shown) such as a display or LED. In addition, upon detecting by a signal received from the sensor 174 that the impedance is not within a preset impedance range for the susceptor, the microcontroller 121 may control the battery 110 to cut off the power applied to the power boosting circuit 122 and therefore prevent heating.

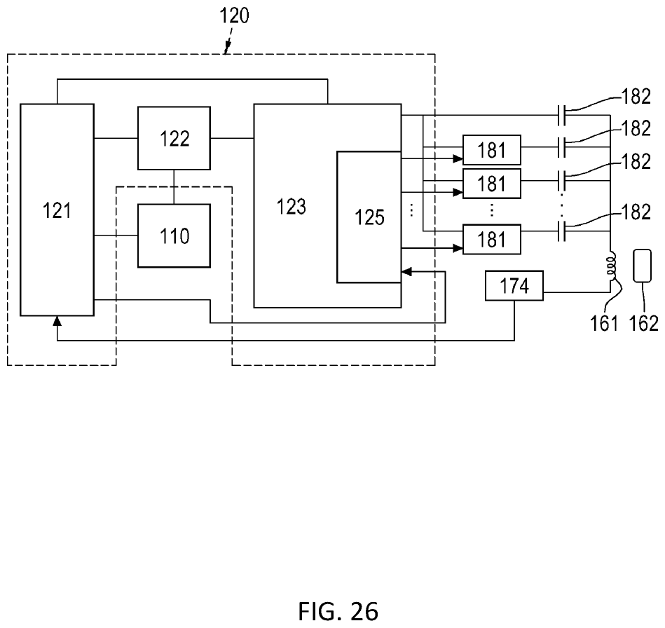

FIG. 26 is a circuit block diagram showing an embodiment of resonance frequency regulation by capacitor switch controlling of the control unit in the complex heating type aerosol generating device according to the present invention.

Referring to FIG. 26, in the complex heating type aerosol-generating device 100, the control unit 120 has a microcontroller 121, a power boosting circuit 122, an induction logic 123, and a control logic 125. A plurality of capacitors 182 are installed between the induction logic 123 and the excitation coil 161. The plurality of capacitors 182 are connected to a plurality of capacitor switches 181, respectively, the capacitor switches 181 are connected to the control logic 125, and the control logic 125 may turn on or off the capacitor switches 181 individually. The capacitor switches 181 are elements that can be turned on or off by the control logic 125, which may be configured as power FETs, MOSFETs, transistors, etc., for example.

The microcontroller 121 may have a preset resonance frequency depending on the material of the susceptor 162. Also, the microcontroller 121 may obtain a preset resonance frequency depending on the material of the susceptor 162 used in the complex heating type aerosol generating device 100 by controlling the control logic 125, which may be included in the induction logic 123, so that the control logic 125 turns on or off the capacitor switches 181 individually, in order to supply an alternating current to the excitation coil 161 with the corresponding resonance frequency depending on the material of the susceptor 162. In some embodiments, a sensor 174 may be provided which is connected to the excitation coil 161 to measure impedance, and the microcontroller 121 may obtain a desired resonance frequency depending on the material of the susceptor 162 by controlling the control logic 125, which may be included in the induction logic 123, so that the control logic 125 turns on or off the capacitor switches 181 individually, in order to detect impedance by a signal received from the sensor 174 and obtain a desired resonance frequency depending on the material of the susceptor 162. The resonance frequency may be increased by turning on the capacitor switches 181, and the resonance frequency may be decreased by turning off the capacitor switches 181. In some embodiments, the sensor 174 may be configured as a current sensor, a voltage sensor, a temperature sensor, a resistance sensor, and so forth.

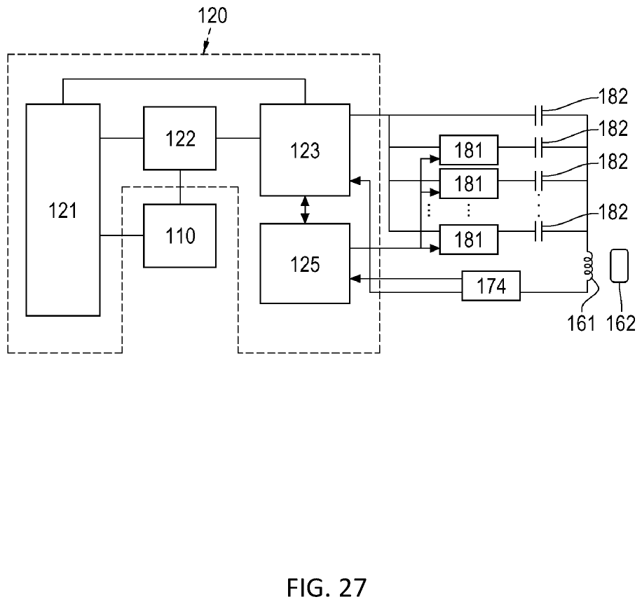

FIG. 27 is a circuit block diagram showing another embodiment of resonance frequency regulation by capacitor switch controlling of the control unit in the complex heating type aerosol generating device according to the present invention.

Referring to FIG. 27, according to another embodiment of the present invention, the induction logic 123 and the control logic 125 are separately configured, and the induction logic 123 and the control logic 125 may be connected via an interface such as I2C, SPI, or GPIO. In some embodiments, a sensor 174 may be provided which is connected between the excitation coil 161 and the induction logic 123 to measure impedance, and the induction logic 123 may obtain a desired resonance frequency depending on the material of the susceptor 162 by controlling the control logic 125 via an interface so that the control logic 125 turns on or off the capacitor switches 181 individually, in order to detect impedance by a signal received from the sensor 174 and obtain a desired resonance frequency depending on the material of the susceptor 162. Moreover, in some embodiments, a sensor 174 may be provided which is connected between the excitation coil 161 and the control logic 125 to measure impedance, and the control logic 125 may obtain a desired resonance frequency depending on the material of the susceptor 162 by turning on or off the capacitor switches 181 individually, in order to detect impedance by a signal received from the sensor 174 and obtain a desired resonance frequency depending on the material of the susceptor 162.

A person with ordinary skill in the art to which the present invention pertains will understand that the present invention may be implemented in a modified form within the scope which does not deviate from the essential characteristics of the present invention. Therefore, the methods disclosed in the above should be considered from an explanatory point of view, not a limited point of view. The scope of the present invention is defined by the claims, not the foregoing description, and all of the differences within the scope equivalent thereto should be interpreted to be included in the scope of the present invention.

According to the present invention, the complex heating type aerosol generating device can allow a user to inhale a smoking article having a variety of different aerosol-forming substrates, by using a plurality of heating means capable of controlling the temperatures of the plurality of aerosol-forming substrates, respectively.

According to the present invention, the complex heating type aerosol generating device can variably control a heating time, without being restricted by inhalation patterns of a user, by sensing a pressure change caused by puffing and controlling on and off of the heating according to the cumulative integral value of puff volume.

1-29. (canceled)

30. A complex heating type aerosol generating device, which is grippable and portable-sized, for a smoking article having a first aerosol-forming substrate and a second aerosol-forming substrate arranged at an upstream of the first aerosol-forming substrate, the complex heating type aerosol generating device comprising:
a cavity into which the smoking article can be inserted;
a first heating means configured to heat an interior or exterior of the first aerosol-forming substrate of the smoking article within a first temperature range;
a second heating means configured to heat an interior or exterior of the second aerosol-forming substrate of the smoking article within a second temperature range;
first and second sensors configured to sense the temperatures of the first and second heating means, respectively;
a rechargeable battery configured to function as a direct current power source; and
a control unit electrically connected to the first and second sensors and the battery, and configured to control the first and second heating means according to the sensed values of the first and second sensors, respectively, by receiving direct current power from the battery.

31. The complex heating type aerosol generating device of claim 30, wherein the first aerosol-forming substrate provided in the smoking article is a liquid cartridge, and wherein the second aerosol-forming substrate provided in the smoking article is a tobacco filler.

32. The complex heating type aerosol generating device of claim 31, wherein the tobacco filler contains glycerin VG.

33. The complex heating type aerosol generating device of claim 31, wherein the liquid cartridge comprises a liquid or gel composition containing glycerin VG.

34. The complex heating type aerosol generating device of claim 31, wherein the smoking article further comprises a filter and a tube, and wherein the filter, the tube, the tobacco filler, and the liquid cartridge are wrapped in single wrapping paper.

35. The complex heating type aerosol generating device of claim 30, wherein the first aerosol-forming substrate provided in the smoking article is a tobacco filler, and wherein the second aerosol-forming substrate provided in the smoking article is a liquid cartridge.

36. The complex heating type aerosol generating device of claim 35, wherein the tobacco filler contains glycerin VG.

37. The complex heating type aerosol generating device of claim 35, wherein the liquid cartridge comprises a liquid or gel composition containing glycerin VG.

38. The complex heating type aerosol generating device of claim 35, wherein the smoking article further comprises a filter and a tube, and wherein the filter, the tube, the tobacco filler, and the liquid cartridges are wrapped in single wrapping paper.

39. The complex heating type aerosol generating device of claim 30, wherein the first aerosol-forming substrate and second aerosol-forming substrate provided in the smoking article are tobacco fillers.

40. The complex heating type aerosol generating device of claim 39, wherein the tobacco fillers contain glycerin VG.

41. The complex heating type aerosol generating device of claim 39, wherein the smoking article further comprises a filter and a tube, and wherein the filter, the tube, and the tobacco fillers are wrapped in single wrapping paper.

42. The complex heating type aerosol generating device of claim 30, wherein the first aerosol-forming substrate and second aerosol-forming substrate provided in the smoking article are liquid cartridges.

43. The complex heating type aerosol generating device of claim 42, wherein the liquid cartridges comprise a liquid or gel composition containing glycerin VG.

44. The complex heating type aerosol generating device of claim 42, wherein the smoking article further comprises a filter and a tube, and wherein the filter, the tube, and the liquid cartridges are wrapped in single wrapping paper.

45. The complex heating type aerosol generating device of claim 30, further comprising a pressure sensor electrically connected to the control unit, wherein the control unit is configured to control the first heating means and/or the second heating means according to a cumulative integral value by calculating an integral value of puff volume according to a sensed value from the pressure sensor.

46. The complex heating type aerosol generating device of claim 30, wherein the first heating means is a resistance heater and the second heating means is an induction heater.

47. The complex heating type aerosol generating device of claim 46, wherein the induction heater is comprised of an excitation coil and a susceptor reacting with the excitation coil such that induction heating occurs due to eddy current losses to heat the smoking article.

48. The complex heating type aerosol generating device of claim 47, further comprising a plurality of capacitor switches connected between the control unit and the excitation coil, wherein the control unit is configured to control a frequency of an alternating current supplied to the excitation coil, by controlling on or off of at least one of the capacitor switches.

49. The complex heating type aerosol generating device of claim 47, further comprising a sensor configured to sense an inductance of the excitation coil.

50. The complex heating type aerosol generating device of claim 47, further comprising a sensor configured to sense an impedance of the excitation coil.

51. The complex heating type aerosol generating device of claim 47, further comprising an insulating part provided between the susceptor and the excitation coil to prevent heat of the susceptor from being transferred to the excitation coil.

52. The complex heating type aerosol generating device of claim 51, wherein in the insulating part, an insulating film using an insulating filler having an insulating and shielding function is attached to an outer wall of an insulating pipe.

53. The complex heating type aerosol generating device of claim 52, wherein the insulating filler comprises ceramic powder.

54. The complex heating type aerosol generating device of claim 47, wherein the susceptor is provided as a hollow pipe inserted into a center of the first aerosol-forming substrate and/or the second aerosol-forming substrate.

55. The complex heating type aerosol generating device of claim 54, wherein the susceptor is made of at least one material selected from the group consisting of stainless steel, nickel, and cobalt.

56. The complex heating type aerosol generating device of claim 47, wherein the susceptor is inserted through the lower center of the smoking article inserted into the cavity and comes into direct contact with the second aerosol-forming substrate in the smoking article.

57. The complex heating type aerosol generating device of claim 46, wherein the resistance heater is a pipe heater with resistance heating patterns.

58. The complex heating type aerosol generating device of claim 30, wherein the first heating means is an induction heater and the second heating means is a resistance heater.

59. The complex heating type aerosol generating device of claim 58, wherein the resistance heater is an invasive heater.

60. The complex heating type aerosol generating device of claim 58, wherein the induction heater is comprised of an excitation coil and a susceptor reacting with the excitation coil such that induction heating occurs due to eddy current losses to heat the smoking article.

61. The complex heating type aerosol generating device of claim 60, further comprising a plurality of capacitor switches connected between the control unit and the excitation coil, wherein the control unit is configured to control a frequency of an alternating current supplied to the excitation coil, by controlling on or off of at least one of the capacitor switches.

62. The complex heating type aerosol generating device of claim 60, further comprising a sensor configured to sense an inductance of the excitation coil.

63. The complex heating type aerosol generating device of claim 60, further comprising a sensor configured to sense an impedance of the excitation coil.

64. The complex heating type aerosol generating device of claim 60, further comprising an insulating part provided between the susceptor and the excitation coil to prevent heat of the susceptor from being transferred to the excitation coil.

65. The complex heating type aerosol generating device of claim 64, wherein in the insulating part, an insulating film using an insulating filler having an insulating and shielding function is attached to an outer wall of an insulating pipe.

66. The complex heating type aerosol generating device of claim 65, wherein the insulating filler comprises ceramic powder.

67. The complex heating type aerosol generating device of claim 60, wherein the susceptor is provided as a hollow pipe inserted into a center of the first aerosol-forming substrate and/or the second aerosol-forming substrate.

68. The complex heating type aerosol generating device of claim 67, wherein the susceptor is made of at least one material selected from the group consisting of stainless steel, nickel, and cobalt.

69. The complex heating type aerosol generating device of claim 58, wherein the resistance heater is a pipe heater with resistance heating patterns.

70. The complex heating type aerosol generating device of claim 30, wherein the first heating means is an induction heater and the second heating means is an induction heater.

71. The complex heating type aerosol generating device of claim 70, wherein each of the induction heaters is comprised of an excitation coil and a susceptor reacting with the excitation coil such that induction heating occurs due to eddy current losses to heat the smoking article.

72. The complex heating type aerosol generating device of claim 71, further comprising a plurality of capacitor switches connected between the control unit and the excitation coils, wherein the control unit is configured to control a frequency of an alternating current supplied to the excitation coils, by controlling on or off of at least one of the capacitor switches.

73. The complex heating type aerosol generating device of claim 71, further comprising a sensor configured to sense an inductance of the excitation coils.

74. The complex heating type aerosol generating device of claim 71, further comprising a sensor configured to sense an impedance of the excitation coils.

75. The complex heating type aerosol generating device of claim 71, further comprising an insulating part provided between the susceptor and the excitation coil of each induction heater to prevent heat of the susceptor from being transferred to the excitation coil.

76. The complex heating type aerosol generating device of claim 75, wherein in the insulating part of each induction heater, an insulating film using an insulating filler having an insulating and shielding function is attached to an outer wall of an insulating pipe.

77. The complex heating type aerosol generating device of claim 76, wherein the insulating filler comprises ceramic powder.

78. The complex heating type aerosol generating device of claim 71, wherein the susceptor of each induction heater is provided as a hollow pipe inserted into a center of the first aerosol-forming substrate and/or the second aerosol-forming substrate.

79. The complex heating type aerosol generating device of claim 78, wherein the susceptor of each induction heater is made of at least one material selected from the group consisting of stainless steel, nickel, and cobalt.

80. The complex heating type aerosol generating device of claim 71, wherein the susceptor of each induction heater is inserted through the lower center of the smoking article inserted into the cavity and comes into direct contact with the second aerosol-forming substrate in the smoking article.

81. The complex heating type aerosol generating device of claim 30, wherein the first heating means is a resistance heater and the second heating means is a resistance heater.

82. The complex heating type aerosol generating device of claim 81, wherein the resistance heaters are pipe heaters each with resistance heating patterns.

83. The complex heating type aerosol generating device of claim 81, wherein the first heating means and the second heating means are integrally formed as an invasive heater inserted through a lower center of the smoking article inserted into the cavity and that comes into direct contact with the first aerosol-forming substrate and the second aerosol-forming substrate in the smoking article.

84. The complex heating type aerosol generating device of claim 81, wherein the resistance heater of the second heating means is an invasive heater.
